SEQUENCE LISTING (25 sequences)

SEQ ID NO: 1 - protein, 458 aa, Lactobacillus
MASEDKKSKREHIIHFEDTPSKSLDEVNGSVEVPHNAGFWKTLAAYTGPGILVAVGYMDPGNWITSIAGGASFKYSLLSVILISSLIAMLLQAMAARLGIVTGRDLAQMTRDHTSKAMGGFLWVITELAIMATDIAEIIGSAIALKLLFNMPLIVGIIITTADVLILLLLMRLGFRKIEAVVATLVLVILLVFAYEVILAQPNVPELLKGYLPHADIVTNKSMLYLSLGIVGATVMPHDLFLGSSISQTRKIDRTKHEEVKKAIKFSTIDSNLQLTMAFIVNSLLLILGAALFFGTSSSVGRFVDLFNALSNSQIVGAIASPMLSMLFAVALLASGQSSTITGTLAGQIIMEGFIHLKMPLWAQRLLTRLMSVTPVLIFAIYYHGNEAKIENLLTFSQVFLSIALPFAVIPLVLYTSDKKIMGEFANRAWVKWTAWFISGVLIILNLYLIAQTLGFVK

SEQ ID NO: 2 - protein, 450 aa, Lactobacillus
MARPDERLTVQREKRSLDDINRSVQVPSVYESSFFQKFLAYSGPGALVAVGYMDPGNWLTALEGGSRYHYALLSVLLMSILVAMFMQTLAIKLGVVARLDLAQAIAAFIPNWSRICLWLINEAAMMATDMTGVVGTAIALKLLFGLPLMWGMLLTIADVLVVLLFLRFGIRRIELIVLVSILTVGIIFGIEVARADPSIGGIAGGFVPHTDILTNHGMLLLSLGIMGATIMPHNIYLHSSLAQSRKYDEHIPAQVTEALRFGKWDSNVHLVAAFLINALLLILGAALFYGVGGHVTAFQGAYNGLKNPMIVGGLASPLMSTLFAFALLITGLISSIASTLAGQIVMEGYLNIRMPLWERRLLTRLVTLIPIMVIGFMIGFSEHNFEQVIVYAQVSLSIALPFTLFPLVALTNRRDLMGIHVNSQLVRWVGYFLTGVITVLNIQLAISVFV

SEQ ID NO: 3 - protein, 535 aa, Lactobacillus
MSDDHKKRHPIKLIQYANGPSLEEINGTVEVPHGKGFWRTLFAYSGPGALVAVGYMDPGNWSTSITGGQNFQYLLISVILMSSLIAMLLQYMAAKLGIVSQMDLAQAIRARTSKKLGIVLWILTELAIMATDIAEVIGAAIALYLLFHIPLVIAVLVTVLDVLVLLLLTKIGFRKIEAIVVALILVILLVFVYQVALSDPNMGALLKGFIPTGETFASSPSINGMSPIQGALGIIGATVMPHNLYLHSAISQTRKIDYKNPDDVAQAVKFSAWDSNIQLSFAFVVNCLLLVMGVAVFKSGAVKDPSFFGLFQALSDSSTLSNGVLIAVAKSGILSILFAVALLASGQNSTITGTLTGQVIMEGFVHMKMPLWARRLVTRIISVIPVIVCVMLTARDTPIQQHEALNTLMNNSQVFLAFALPFSMLPLLMFTNSKVEMGDRFKNTGWVKVLGWISVLGLTGLNLKGLPDSIAGFFGDHPTATQTNMANIIAIVLIVAILALLAWTIWDLYKGNQRYEAHLAAVADEKEAKADVDEQ

SEQ ID NO: 4 - protein, 458 aa, Lactobacillus casei
MASEDKKSKREHIIHFEDTPSKSLDEVNGSVEVPHNAGFWKTLAAYTVPGILVAVGYMDPGNWITSIAGGASFKYSLLSVILISSLIAMLLQAMAARLGIVTGRDLAQMTRDHTSKAMGGFLWVITELAIMATDIAEIIGSAIALKLLFNMPLIVGIIITTADVLILLLLMRLGFRKIEAVVATLVLVILLVFAYEVILAQPNVPELLKGYLPHADIVTNKSMLYLSLGIVGATVMPHDLFLGSSISQTRKIDRTKHEEVKKAIKFSTIDSNLQLTMAFIVNSLLLILGAALFFGTSSSVGRFVDLFNALSNSQIVGAIASPMLSMLFAVALLASGQSSTITGTLAGQIIMEGFIHLKMPLWAQRLLTRLMSVTPVLIFAIYYHGNEAKIENLLTFSQVFLSIALPFAVIPLVLYTSDKKIMGEFANRAWVKWTAWFISGVLIILNLYLIAQTLGFVK

SEQ ID NO: 5 - protein, 459 aa, Lactobacillus brevis
MKNHETDTKTKHHMIESTGSGQKSLDEVNGTVEVPQNAGFWRTLMAYTGPGALIAVGYMDPGNWITSIAGGAQYKYTLLTVVLLSSLVAMLLQAMSARLGIVTGKDLAQLTREHTGKRTGFALWIITELAIMATDIAEIIGSAIALKLLFGFPLIVGIIITAMDVLVLLVLMKLGFRKIEAIVATLVAVILFVFLYEVILAQPHMGEVLKGYLPSSTVVTNHGMLYLSLGIVGATVMPHDLYLGSSISQTRSFDRKNRKSVAQAIKFTTIDSNIQLTLAFVVNSLLLILGAALFFGTNSDLGRFVDLFNALSDSQIVGAIASPMLSMLFALALLSSGQSSTITGTLAGQIIMEGFINLKMPLWAQRLITRLLSVTPVIIFAIIYHGNEAKIEDLLTFSQVFLSIALPFAMIPLVIFTSSKKLMGEFANRTWSKILGWIIAVILIILNIYLILNTLHIVQ

SEQ ID NO: 6 - protein, 447 aa, Pediococcus acidilactici
MSKKLDEVDNKSLDEINGSIKVPKNAGFFKTLMAYTGPGILIAVGYMDPGNWITSIAGGAQFKYTLLSVVLISSLIAMLLQAMSARLGIVTGKDLAQLTRERTSKRVGFMLWVVAELAIMATDIAEIIGSGIALELLFHIPLIIGILITAADVLILLLLMRLGFRKIEAIVATLVMVILIVFAYEVFLSDPSISGIIKGYVPAPVILQNNSMLYLSLGIVGATVMPHDLYLGSSISQTREIDRRDRKNVAQAIRFSTIDSNMQLFLAFIVNSLLLILGAALFYGTDSSLGRFVDLFNALSDNQIVGAIASPMLSMLFAVALLASGQSSTITGTLSGQIIMEGFIRLRVPLWVQRLVTRLLSVAPVLIFAIYYHGDEAKIENLLTFSQVFLSVALPFAVIPLVMYTSSKKLMGEFANRQWVKWCAWIATIILILLNIYLILQTLGIVK

SEQ ID NO: 7 - protein, 464 aa, Lactobacillus plantarum
MKSAKTKDHAKMKAAEEKAIHSTGADSKSLDEVNGSVRVPKDASFWRTLIAYTGPGALVAVGYMDPGNWITSIAGGSQYKYALLSVILLSSLIAMLLQAMAARLGIVTGKDLAQLTRERTSKGMGIFLWIITELAIMATDVAEIIGSGIALKLLFGFPLIVGILITTADVLILLLLMKLGFRKIEAIVATLVAVILFVFLYEVIISQPNIPEMLKGYVPTSRIVSNRSMLFLALGIVGATVMPHNLYLGSSISQTRQVDRSDEKEVAKAVKFTTIDSNIQLSVAFVVNSLLLILGAALFFGTKGDLGRFVDLYNALGDSKVVGSIASPLLSMLFAIALLSSGQSSTITGTLSGQIIMEGFIRLKMPLWAQRLLTRLISVTPVLAFAIYYHGNEAKIEDLLTMSQVFLSIALPFAMIPLVMFTSNRALMGNFTNRVWVKWTAWIVTVILIILNIYLILQTVGLVK

SEQ ID NO: 8 - protein, 443 aa, Lactobacillus sakei
MHYADGSSLEEINNTVAIPKNAGFWKTLMAFMGPGALVAVGYMDPGNWITSIAGGAQFAYTLISVILVSNLIAMLLQAMAARLGIVTGMDLAQMTRAKTGKKMGIFLWIVTELAIMATDIAEIIGSAIALELIFNIPLLWGVLITAFDVLLLLLLMKLGFRKIEAIVATLVAVILFVFLYEVILAQPNMGDVVRGFVPSPRIMTDKKMLFLALGIVGATVMPHNLYLHSSIAQARQYDRDDVAEKRKAIKFTVIDSNIQLTIAFVVNCLLLILGAAMFYGTNSDLGRFVDLFNALQNKEIVGSIASPMLSLLFAVALLASGQNSTITGTLSGQIVMEGFVRMKIPLWARRVITRGLSILPVIIFTVYYHGNEAQVENLLIYSQVFLSIALPVSMIPLTLFTSDEKIMGPFVNRPWVKYTAWFVTIVLTLLNIYLILQTVGLAA

SEQ ID NO: 9 - protein, 454 aa, Lactobacillus alimentarius
MSSKNKKHESLIHYANGPSLEEINDTVEIPKDAGFFKTLLAYSGPGALVAVGYMDPGNWVTSIAGGAQFKYKLLSVILISSLIAMLLQYMSAKLGIVTGRDLAQLTRDRTSRVGGFILWIITELAIMATDIAEIIGSAIALKLLFNIPVLWGVIITAFDVLLLLVLMKLGFRKIEAIVATLIMVILLVFLYEVILAKPDVGQMMVGFIPEPKILQNQSMLYLSLGIVGATVMPHNLYLHSSISQARKYDRDDPKSIHQAVRFSTWDSNIQLTLAFVVNTLLLLLGAALFYGTSSDLGRFVDLFNALQDPKVAGAVASPVLSILFAVALLASGQNSTITGTLSGQIVMEGFIHMKMKLWARRVITRLMSIIPVITFAIIYHGNEAKIESLLTFSQVFLSVALPFSIFPLIKFTSNKKLMGEFVNNKLVEYIGYFVAIVLTILNIWLIYTTFVPTA

SEQ ID NO: 10 - protein, 451 aa, Lactobacillus floricola
MTKEETKLFHYADGPSLEEINGTVAVPKKGGFWKTLFAFSGPGALVAVGYMDPGNWVTSIAGGAQYQYTLLSVILISSLIAMLLQAMSARLGIASGLDLAQATAKHSPKWLRYTLWIITELAIMATDIAEIVGAAIALKLLFNLPLIVGIFLTTLDVMLLLLLMKLGFRKIEAIVGALIVSILVIFLYEVILARPDVGAMFAGYIPQPEVVTNKGAFYIALGIVGATVMPHNLYLHSSIAQARQYDRNDIEEKKRAIKFTVLDSNIQLSVAFVVNTLLLLLGAALFYGAQTDLGTFSELYNALQNPQVAGVIASPILSVLFAVALLASGQNSTITGTLSGQIVMEGFIHLKMPMWARRVITRLISVIPVLIFAIIYHSNEAKIEDLLVFSQVFLSIALPVSIIPLVMFTANKKIMGPFVNKKWVTITSSLVAIILTGLNIFLILQTLGWVQ

SEQ ID NO: 11 - protein, 455 aa, Lactobacillus brevis
MTDNVSAKSVQGDLTNGPSLAEINGSVRVPKEKGFVRNLLAFSGPGALVAVGYMDPGNWVTSIGGGAQYGYLLMSVILMSSLIAMLLQYMAAKLGIVTQMDLARATRAHTGKRIGAVLWVMTELAIMATDIAEVIGGAIALKLLFGVPLILGVSLTVLDVLLLLLLTRLGFRKIEAIVLCLILVILVVFAYEVVIAQPSMGQAVASFVPQAEIMRPGQLTMALGIVGATVMPHNLYLHSSIAQTRKFDRQDPAEMARAVKFTAWDSNIQLFGAFIINCLLLLLGAAMFFGKDAGALGTFGQLYDALQDNRLAGAVASPVLSTLFAVALLASGQNSTITGTLTGQVIMEGFINMRLPIWVRRLVTRLISVAPVIIVTILYGGSEQALDRLLVNSQVFLSIALPFSMIPLTIFTSSKRIMGTRWVNRWWVTALAWGCTAILTVLNIQIVWATMTTLF

SEQ ID NO: 12 - protein, 450 aa, Lactobacillus casei
MARPDERLTVQREKRSLDDINRSVQVPSVYESSFFQKFLAYSGPGALVAVGYMDPGNWLTALEGGSRYHYALLSVLLMSILVAMFMQTLAIKLGVVARLDLAQAIAAFIPHWSRICLWLINEAAMMATDMTGVVGTAIALKLLFGLPLMWGMLLTIADVLVVLLFLRFGIRRVELIVLVSILTVGIIFGIEVARADPSIGGIAGGFVPHTDILTNHGMLLLSLGIMGATIMPHNIYLHSSLAQSRKYDEHIPAQVTEALRFGKWDSNVHLVAAFLINALLLILGAALFYGVGGHVTAFQGVYNGLKNPMIVGGLASPLMSTLFAFALLITGLISSIASTLAGQIVMEGYLNIRMPLWERRLLTRLVTLIPIMVIGFMIGFSEHNFEQVIVYAQVSLSIALPFTLFPLVALTNRRDLMGIHVNSQLVRWVGYFLTGVITVLNIQLAISVFV

SEQ ID NO: 13 - protein, 451 aa, Lactobacillus rhamnosus
MTKRNEQLSVQQAKPSLDEINRSVQVPGVYEPSFVQKFLAYSGPGALVAVGYMDPGNWLTALEGGSRYHETLLAVLLLSILAAMFMQTLAIKLGVVARLDLAQAIAAFVPKWSRIGLWLVNEAAMMATDMTGVVGTAIALKLLFGLPLMWGMLLTIADVLVVLMFLRFGIRRIELIVLASILTVGIIFGIEVVRARPSMGGIVAGLVPHTEILTNRGMLLLSLGIMGATIMPHNIYLHSSLAQSRRYDEHIPAQVTEALRFGKWDSNVHLVAAFIINALLLILGATLFYGMSSHATAFEGVYNGLKNPAIVGGLASPLMSTLFAFALLITGLISSIASTLAGQIVMEGYLNIQIPLWARRLLTRLVTLIPIMIIGFVMGFSEQHFEQVIVYAQVALSIALPFTLFPLVALTDRRDLMGQHVNSPVVRWMGYVLTGIITLLNVQLILSVILP

SEQ ID NO: 14 - protein, 442 aa, Lactobacillus kefiri
MSQEPTHKSLDEINQSVEVPSVYETSFLQKFLAYSGPGALVAVGYMDPGNWLTSLSGGSQFRYALLSVLLMSILVAMFMQTLSIKLGVVARLDLAQAIAQKVPKSGRYTLWIINELAMMATDMTGVVGTAIALKLLFGLPLVYGILLTIFDVLLVLLFLRFGIRRIEFIVLAAILIVGVIFGIEVTRATPNIVEIAGGLIPTTHIVTNHEMLIMSLGIVGATIMPHNVYLHSSLAQSRRYDYHNPKQVNEALRFAKWDSNVHLVAAFLINALLLVLGGTLFFHTNSHFSAFQDVYNGLKSSAIVGSLASPLMSTLFAFALLITGMISSITSTLSGQIVMEGYLHIRLPLWERRLLTRFVTLIPILAIGFLVGFNDHDFEEIIVYAQIALSIALPFTLFPMVALTSNHDLMGVHTNRRYVTVIGYLLTSIITILNLQFVLASI

SEQ ID NO: 15 - protein, 439 aa, Lactobacillus alimentarius
MPNKKSLDEINESVKVPSVYDTSFLQKFLAYSGPGALVAVGYMDPGNWLTSLSGGSQYRYDLLSVLLISILVAMFMQTLSIKLGVVARLDLAQAIATKVSKPIRYFLWILNEIAMMATDLTGVIGTAIALKLLFNLPLVFGILLTVFDVLIVLIFLRFGIRRIEFIVLAAILTVGIIFGIEVFRAQPKLFSIISGVIPSTDLFTNHRKLVLSLGIVGATIMPHNIYLHSSLAQSRRYDHNDPLQVNEALRFAKWDSNVHLIAAFIINALLLVLGGTLFYHMTNQLASLQDVFTGLKSHAIVGTLASPLMSWLFAFALLITGMISSITSTLSGQIVMEGYLNIRLPLWQRRLLTRFVTLIPILIIGFIVHFNEQDFENLIVYAQIILSIALPFTLFPMIFLTNDKKIMGNHVNSKLTTTVGIILASAITILNLQLLFSLI

SEQ ID NO: 16 - protein, 441 aa, Lactobacillus plantarum
MQSHRHQSLEEINQSVAVPDVHQTAFWRKFLAYSGPGALVAVGYMDPGNWLTSLAGGGQFQYRLLAVLALAIIVAMFMQGLAIRLGVVARQDLAQAIASKLPRPVRYAAWILNEVAMMATDMTGVIGTAIALKMLFGLPLLAGILLTIADVLVVLLFLRFGIRRVEVIVLVAILTVGIIFGIEVGRAHVQFGNVLLGLVPTPLIVKNHTALVLSLGILGATIMPHNLYLHSSLAQSRRYDYHNPAQVTEALRFANWDSTVHLIAAFLINALLLVLGGTLFFGHTNALASLQAVFDGLKSTTVVGALASPVMSWLFALALLITGLISSITSTLAGQIVMEGYLHIRLPLWQRRLLTRAVTLIPILIIGMLVGFSDAAFENLIIYAQVALSIALPFTLLPLVALTNDASLMKAHVNRPAVTWVGYGLAGIITVLNIYLVYSLF

SEQ ID NO: 17 - protein, 434 aa, Lactobacillus reuteri
MERKSLDEINGSVDVPNVYQSAFWQKFLAYSGPGALVAVGYMDPGNWLTSLAGGSQYRYQLLVVLFTAILIAMYMQSLAIKLGVTTRTDLAQAIARRLPTPLRIALWLFNEIAMMATDLTGVVGTAVALNMLFKLPLLIGVLLTIADVLVVLFFLHFGIRRIEFIVLTAILVVGAIFAIEVCRAHPEFSAIMDGFVPRSTIFTNHSELLISLGIVGATIMPHNIYLHSSLAQSRRYDEHDPKQVKETLRFANWDSLIHLFAAFIVNALLLILGGTLFFHAASLGSLEDVFFGLKNPQIVGSLASPLMSWLFAFALLVTGLISSITSTLAGQIVMEGFINIRLPLWKRRLLTRAVTLVPILIIGFMINFKEEQFEQLIIYAQIVLSIALPFTLYPLVALTGNKKLMGPHVNSRWQTVLGYILASLVTGLNLLVLV

SEQ ID NO: 18 - protein, 440 aa, Lactobacillus crustorum
MTEKKSLDEINGSVAVPQYNTSFFRKFLAYSGPGALIAVGYMDPGNWLTSLVGGAHHKYQLLSVLLISILVATFMQSLSIRLGIASRQDLAQAIAKKAKKPVRYCLWIINELAMMATDLTGVIGTALALNMLFKLPLVFGVLITILDVFLILWFMRFGIRRIESIVVISILTVGLIFAFEVSHVQPNLTAIFKGFVPSQTIITNQNKLILSLGIIGATIMPHNIYLHSALAQSRRYDYHDSRQVREALRFANWDSIVHLIAALIINCLLLILGGTIFYDKADQLASLMTVFKGLMNYQVVGSLASSFMSYLFAFALLVTGLISSITSTLSGQIVMEGYLNIRLPLWQRRLLTRIITLIPILVIGFLVHFNEVIFEDLIVYAQIALSVALPFTLFPLVYLTNNAKIMGKHVNKKWQTILGFVLALIITILNIVLIATTLSH

SEQ ID NO: 19 - protein, 535 aa, Lactobacillus casei
MSDDHKKRHPIKLIQYANGPSLEEINGTVEVPHGKGFWRTLFAYSGPGALVAVGYMDPGNWSTSITGGQNFQYLLISVILMSSLIAMLLQYMAAKLGIVSQMDLAQAIRARTSKKLGIVLWILTELAIMATDIAEVIGAAIALYLLFHIPLVIAVLVTVLDVLVLLLLTKIGFRKIEAIVVALILVILLVFVYQVALSDPNMGALLKGFIPTGETFASSPSINGMSPIQGALGIIGATVMPHNLYLHSAISQTRKIDHKNPDDVAQAVKFSAWDSNIQLSFAFVVNCLLLVMGVAVFKSGAVKDPSFFGLFQALSDSSTLSNGVLIAVAKSGILSILFAVALLASGQNSTITGTLTGQVIMEGFVHMKMPLWARRLVTRIISVIPVIVCVMLTARDTPIQQHEALNTLMNNSQVFLAFALPFSMLPLLMFTNSKVEMGDRFKNTGWVKVLGWISVLGLTGLNLKGLPDSIAGFFGDHPTATQTNMANIIAIVLIVAILALLAWTIWDLYKGNQRYEAHLAAVADEKEAKADVDEQ

SEQ ID NO: 20 - protein, 535 aa, Lactobacillus rhamnosus
MSDDHKKKHSMKLIQYANGPSLEEINGTVEVPHGKGFWRTLFAYSGPGALVAVGYMDPGNWSTSITGGQNFQYLLISVILMSSLIAMLLQYMAAKLGIVSQMDLAQAIRARTSKKLGIVLWILTELAIMATDIAEVIGAAIALYLLFHIPLVIAVLVTVLDVLVLLLLTKIGFRKIEAIVVALILVILLVFVYQVALSDPNMGALLKGFIPTGETFASSPSVNGMSPIQGALGIIGATVMPHNLYLHSAISQTRKIDHKDPEDVAQAVKFSAWDSNIQLTFAFVVNCLLLVMGVAVFKSGAVKDPSFFGLFQALSDSSTLSNGVLIAVAKSGILSILFAVALLASGQNSTITGTLTGQVIMEGFIHMKMPLWARRLVTRVISVIPVIVCVMLTARETPIQQHEALNTLMNNSQVFLAFALPFSMLPLLMFTNSKVEMGDRFKNTGWVKVLGWVSVIGLTYLNLKGLPDSIAGFFGDNPTAAQTNIANMIAYVLIAAVLALLAWTIWDLYKGNKRYEAHLEAVADEEEAKANDDVQ

SEQ ID NO: 21 - protein, 530 aa, Lactobacillus plantarum
MSEKTNTPNRKHKLIEYANGPSLEEINGTIEVPKNLNFWKTLFAYSGPGALVAVGYMDPGNWSTSITGGQNYQYMLMSVILISSLIAMLLQYMAAKLGIVSQMDLAQAIRARTSKSLGIVLWILTELAIMATDIAEVIGAAIALYLLFNIPLVIAVFITVLDVLVLLLLTKIGFRKIEAIVVCLILVILFVFVYQVALSNPDWGGVIKGLVPTADTFSTSRSVNGMTPLSGALGIIGATVMPHNLYLHSAISQTRKIDHNDEEDVARTVKFAAWDSNIQLSFAFVVNSLLLIMGVAVFKSGAVKDPSFFGLYEALSNTSMLSNGILISVAKSGALSALFAIALLASGQNSTITGTLTGQVIMEGFVHMRMPLWLRRLVTRLISVIPVLICVLLTSGKSAIDEHTALNNLMNNSQVFLAFALPFSMLPLLMMTDSAAEMGKRFKNSLWIKGLGWLSVIGLTFLNLLGLPDSILGFFGDNPSAGEQTFSKILAYLLIAAILALLVWTVFDLQRGNKRYVEQQLAAAAKEANK

SEQ ID NO: 22 - protein, 530 aa, Pediococcus acidilactici
MSNEIKNPKKRRKLISYANGRSLEEINGTVKVPKNIGFWKTLFMYSGPGALVAVGYMDPGNWSTSITGGQNFQYMLMSIILISSLIAMLLQYMAAKLGIVSQMDLAQAIRARTSRALGIVLWILTELAIMATDIAEVIGAAIALYLLFHIPLVVAVFITVFDVLLLLLLTKIGFRKIEAIVVCLIMVILVVFVYQVALSHPSWGAVFGGLIPTTKAFATTPTVGGMTPLSGSLGIIGATVMPHNLYLHSAVSQTRKINHDDEEDVARTVRFSTWDSNIQLSFAFVVNALLLVMGVAVFKTGAVQDPSFFGLFHALNDTSTLSNGILIGVAKTGILSTLFAVALLASGQNSTITGTLTGQVIMEGFVHMRMPLWARRLITRLISVVPVLICVMLTSGKGTIQEHEALNNLMNNSQVFLAFALPFSMVPLLMMTDSRVEMGDRFKNSWIVRILGWISVIFLTYLNLTGLPDSIAAFFGENASAAEISMAHDIAYALIVAVLALLAWTVIELYKGNKRYEIELAEKANAKEAA

SEQ ID NO: 23 - protein, 521 aa, Lactobacillus salivarius
MVNNENNHKKHKMIQYANGKSLEEANGTVEIPKGKGFWKTLFAYSGPGALVAVGYMDPGNWSTSITGGQNFQYLLMSVILLSSLIAMLLQYMAAKLGIVSQMDLAQAIRARTSKALGIVLWILTELAIMATDIAEVIGAAIALYLLFDIPLIIAVFITVFDVLLLLLLTKVGFRKIEAIVVCLIFVILFVFVYQVALSNPDWGGVFKGLIPTSETFAKHPVVHDMSPLNGALGIIGATVMPHNLYLHSAISQTRKFDRNNEDDIANAVRFTAWDSNIQLGLAFVVNSLLLIMGVAVFKSGAVEDPSFFGLYQALSDTSVMSNGLLAAAARTGILSTLFAVALLASGQNSTITGTLTGQVIMEGFIHLRMPLWARRLITRLLSVIPVLICVALTSGKSTIEEHEALNNLMNNSQVFLAFALPFSMLPLVIMTGSKVEMGERFKNRLWINILGWISVISLTYLNMIGLPQNLEPFFPADKVGLAHTVAYILIVLIIALLIWTLVELHLGNKRFAAEQAKKHNK

SEQ ID NO: 24 - protein, 520 aa, Lactobacillus fermentum
MDNTKNQHRKLRLIEHANGKSLEEINGTVEVPHGKGFFRTLFAYSGPGALVAVGYMDPGNWSTSITGGQSFQYTLMTTILISSLIAMLLQYMAAKLGIVSQMDLAQAIRARTGKALGVILWLMTELAIMATDIAEVIGAAIALNLLFHIPLVLAVFITVLDVLVLLLLTKIGFRKIEAIVACLILVILAVFAYQVALSHPDWAGVFKGLLPTKEAIAKEPVVGGISPLTGSLGIIGATVMPHNLYLHSAISQTRKIDHTNAEDIKQTVRFTAWDSNIQLTLAFFVNALLLIMGVAVFKNGAVQDSSFFGLYDALNNTDMLSNGLLIAVAKSGVLSTLFAIALLASGQNSTITGTLTGQVIMEGFVHMKMPLWARRLITRLLSVVPVLVCVAMTAHESTIDQHASLNILMENSQVFLAFALPFSMLPLLIMTNSDTEMGQFKNSLWVRVLGWISVIGLTFLNLYNLPQTYEGFGIWSKGLSDVLAWISIVVIVVLLAWTCFELIRGDRRLAAEREKHTWEK

SEQ ID NO: 25 - protein, 533 aa, Lactobacillus amylolyticus
MCSRKVLLTKQKGKHYLIRYANGKSLSEINGTIEIPKKRTFWRMLWAYTGPGALVAVGYMDPGNWATSITGGQSFQYILMSTILISSLMAMLLQYMAAKLGIVTQMDLAQAIRLRTGKALGIVLWLMTELAIMATDIAEVIGAAIALNLLFDIPLVPAVFITVLDVLLLLLLARIGFRKIEAVVSCLILVILLVFVYEVLLSNPDWSKAFVGLVPSAKIIQTHPVVGGISPLTGTLGIIGATVMPHNLYLHSAISQTRKINHHNLQLIRDAVKYTALDSNIQLSLAFLVNALLLIMGAAVFKSGAVRDSSFFGLYQALDNAKMLSDPLLVHVARTGILSTLFAVALLASGQNSTITGTLTGQVIMEGYIHLKMPLWARRLVTRLLSVIPVLLCVSFTMNDSVMQQHFALNMLMENSQVFLAFALPFSVLPLLIMTNNKAEMGEFKNKPLWHYLGWACALVLTFLNLYNLPSQFVNFKFASKEVSTIIAYFVIVVIAALLLWTCIEIYIGDRKVKIHHSGFDAKEKELKEEGQK

(19) United States
(12) Patent Application Publication
(10) Pub. No.: US 2022/0386639 A1
(43) Pub. Date: Dec. 8, 2022

(54) BACTERIAL COMPOSITION FOR CONTROLLING FUNGAL SPOILAGE AND USES THEREOF

(71) Applicant: Chr. Hansen A/S, Hoersholm (DK)

(72) Inventors: Anisha GOEL, Hoersholm (DK); Cecilie Lykke Marvig NIELSEN, Hoersholm (DK); Helle Skov GULDAGER, Hoersholm (DK); Silja Kej DIEMER, Hoersholm (DK); Karen Lise Vestergaard ANDERSEN, Hoersholm (DK)

(73) Assignee: Chr. Hansen A/S, Hoersholm (DK)

(21) Appl. No.: 17/769,704

(22) PCT Filed: Oct. 21, 2020
(86) PCT No.: PCT/EP2020/079555

§ 371 Date: Apr. 15, 2022

(30) Foreign Application Priority Data
Oct. 23, 2019 (EP) 19204876.7

(51) Int. Cl. A23C 9/123; A23L 3/3571; A23L 3/358; A23C 9/13

(52) U.S. Cl. CPC A23C 9/1234; A23L 3/3571; A23L 3/358; A23C 9/1322; A23V 2002/00; A23Y 2220/73; A23Y 2220/63

(57) ABSTRACT

The present invention relates to a direct vat set starter culture composition comprising lactic acid bacteria comprising a manganese transporter for fermenting a food product and for inhibiting or delaying growth of fungi in said food product, characterized in that the composition comprises up to 600 ppm of manganese.

### FIELD OF THE INVENTION

The present invention relates to a highly concentrated starter culture composition and preparation thereof for controlling of fungal spoilage without resorting to preservatives, such as chemical preservatives. Thus, the present invention contributes for a demand of less processed and preservative-free foods, while simultaneously contributes to provide an effective solution to manage yeast and mold growth. The invention also relates to a food product comprising said composition.

### BACKGROUND

A major problem in the food industry is spoilage by unwanted microorganisms. According to the Food and Agriculture Organization (FAO), one in every four calories intended for human consumption is ultimately not consumed by humans. In a time of food shortages, with more than 800 million people suffering from hunger, the topic of food waste has become a prioritized issue for global policy makers and food manufacturers. In addition to the negative social and economic impacts for society, wasted food also inflicts a host of related environmental impacts, including unnecessary greenhouse gas emissions and inefficient uses of scarce resources such as water and land.

Yeasts and molds are highly efficient at causing foods to spoil and are a problem for most food manufacturers. Spoilage due to yeasts and molds is clearly visible as patches of mold or discoloration on the surface of the food product, allowing it to be disposed of prior to consumption. Yeasts tend to grow within food and drink matrices in planktonic form and they tend to ferment sugars, growing well under anaerobic conditions. In contrast, molds tend to grow on the surface of products in the shape of a visible mycelium made up of cells.

Use of antifungal microbial agents for food biopreservation is known, for example described in Salas et al. “Antifungal microbial agents for food biopreservation—a review.” Microorganisms 5.3 (2017): 37.

In particular in the dairy sector, 29 million tons of dairy products go to waste every year in Europe. One of the main challenges in keeping dairy products fresh is to manage contamination by yeast and mold, which are naturally present everywhere, especially if there are disruptions in the cold chain from production to the consumer's table.

For economic and environmental reasons, there is a constant need for novel or improved ways which are effective for controlling yeast and mold contamination.

### SUMMARY OF THE INVENTION

Manganese has been considered to be vital to human health and therefore an essential trace element. Manganese is essential to the proper functioning of both humans and animals, as it is required for the functioning of many cellular enzymes, such as manganese superoxide dismutase, pyruvate carboxylase, and it can serve to activate many others like kinases, decarboxylases, transferases and hydrolases.

Manganese can be found naturally in many food sources including leafy vegetables, nuts, grains and animal products. Typical ranges of manganese concentrations in common foods are for example 0.4-40 ppm in grains products, 0.1-4 ppm in meat, poultry, fish and eggs, 0.4-7 ppm in vegetable products, 0.03 ppm in homogenized milk.

Besides being dietary supplements, manganese is sometimes added in fermented products as an active ingredient to enhance growth of Bifidobacteria in milk (see e.g., WO2017/021754, Compagnie Gervais Danone, France).

It is recently discovered that manganese is an important growth constraint for fungal growth in food products. It is therefore possible to apply manganese scavenging agents, such as manganese scavenging bacteria, in a food product to compete with the fungus for free manganese. This results in the depletion of this nutrient, which consequently inhibits or delays fungal growth. Such bacteria may be used as starter culture for fermented food products. The invention is related to the preparation of such antifungal bacteria for industrial application.

The present invention is based partly on the surprising finding that when high level of manganese is used in preparing the starter culture during upscaling process, a common practice in the field, the bacteria become less effective in inhibiting or delaying fungal growth when applied in the food product later. Accordingly, bacteria during upscaling process should not be exposed to high level of manganese because such level will negatively influence its antifungal activity. In other words, the inventors have discovered that the manganese level contained in the bacterial composition is closely related to its antifungal activity.

The present invention is related to highly concentrated biomass compositions which include single or multiple lactic acid bacterial strains which inhibit yeast or mold growth. The biomass composition can be prepared by cultivating the bacteria in growth medium and up-concentrate the bacteria.

Commercial starter cultures may commonly be distributed as frozen or freeze-dried (FD) cultures. Highly concentrated cultures are commercially very interesting since such cultures can be inoculated directly into milk without intermediate transfer. Highly concentrated cultures may be referred to as direct vat set (DVS)-cultures.

Commercial highly concentrated DVS-starter cultures may be as freeze-dried or lyophilized cultures in the form of a powder. In this form, the starter can be shipped without refrigeration.

Lactic acid bacteria are normally supplied to the food industry such as dairy industry either as frozen or freeze-dried cultures for bulk starter propagation or as so-called “Direct Vat Set” (DVS) cultures, intended for direct inoculation into a fermentation vessel or vat for the production of a dairy product, such as a fermented milk product or a cheese, without the necessity of preparing a bulk starter.

Direct vat set starters cultures are highly concentrated biomass (typically 10¹⁰ to 10¹² cfu/g) added directly to the vat. Advantages include reduction in risk of phage attack, flexibility of use, mixed strain and species cultures are available, and propagation facilities are not required. Freeze-dried cultures are usually stored at −18° C. but frozen cultures require cooling with dry ice during transit and storage at −45° C.

Typical production processes for starter cultures contain the following steps: (a) handling of inoculation material, (b) preparation of media, (c) propagation of cultures in fermenters under pH control, (d) concentration, (e) freezing, (f) drying and (g) packaging and storage. The steps in the production of starter cultures are important for obtaining the desired identity, purity and quality of the culture product. Cultures used as direct inoculation material are prepared under aseptic conditions, and transfers are kept to a minimum.

Growth media for the production of cultures may contain selected milk components and supplemented with various nutrients, such as yeast extract, vitamins and minerals. The culture growth medium is heated to an ultra-high temperature and cooled to either 30 or 40° C. for mesophilic or thermophilic cultures, respectively. After inoculation of the culture, growth is optimized by maintaining the pH at 6.0-6.3 for mesophilic cultures and at 5.5-6.0 for thermophilic cultures by the addition of an alkali, such as NaOH or NH₄OH.

Processing parameters such as temperature, agitation rate and headspace gases in the fermenters are adjusted to produce cell suspensions much more concentrated than a bulk starter. After fermentation, which is normally a batch fermentation in vessels with a capacity from 10,000 to 40,000 L, the contents are cooled, and the biomass is harvested, giving a further 10-20-fold concentration of the cells. A separator apparatus is commonly employed to separate the aqueous liquid to collect the bacteria.

There is a constant need for a higher yield of biomass due to cost-effectiveness and efficiency. For DVS use, it is desirable to have the bacterial cultures as concentrated as possible, and at the same time, with as high cell recovery as possible.

In order to comprise sufficient bacteria a commercial relevant highly concentrated culture generally has high level of manganese. It is known in the art that manganese enhances the growth of bacteria, in particular lactic acid bacteria. This is an important economic consideration to starter culture manufacturers to whom yield of biomass is of primary concern (Raccach, M. “Manganese and lactic acid bacteria.” Journal of food protection 48.10 (1985): 895-898).

EP2119766 discloses that manganese can increase the growth yield of lactic acid bacteria.

EP0130228 discloses that manganese salt can be used for rapid fermentation for lactic acid bacteria. Manganese has been routinely added, for example, in the form of a food-grade manganese salt in appropriate amount to enhance cell growth.

The final concentrated culture often contains high level of manganese. Examples of food-grade manganese salts which can be used include manganese chloride, manganese oxide, manganese sulfate, manganese citrate, manganese glycerophosphate, manganese gluconate, and the like. The manganese salt can be added to the fermentation medium before inoculation with the bacteria, or simultaneously with said inoculation.

The present invention generally relates to a composition comprising lactic acid bacteria meant for addition into a product such as a food product. The bacterial composition can be used as a starter culture composition for food product. It may be added into a food product or added to ferment the food product and to manage fungal growth at the same time. The composition is characterized in that it contains low or reduced levels of manganese. The term “starter culture” as used in the present context refers to a culture of one or more bacteria is able to acidify the food product.

In the first aspect, the application provides a starter culture composition comprising lactic acid bacteria and low levels of manganese, such as up to 600 ppm manganese. The composition can be used to take up free manganese which is otherwise available for yeast(s) or mold(s) in the product. The inventors have shown that common yeasts and molds inhibited by the composition as disclosed.

Archibald et al. 1984 explored the uptake of manganese by L. plantarum 14917 (Archibald et al. “Manganese acquisition by Lactobacillus plantarum.” Journal of bacteriology 158.1 (1984): 1-8). As disclosed, high manganese content of L. plantarum 14917 was generated by a specific high-affinity, high velocity uptake system. However, the work does not concern growth inhibition of contaminating yeast and/or mold in food products. Neither does it disclose any preparation of highly concentrated direct vat set starter culture, such as frozen-direct vat set (F-DVS) or a freeze-dried vat set (FD-DVS).

In one aspect, the present invention provides a direct vat set starter culture composition comprising one or more anti-fungal lactic acid bacteria for fermenting a food product and for inhibiting or delaying growth of fungi in said food product, characterized in that the composition comprises up to 600 ppm of manganese and that the concentration of the lactic acid bacteria is of at least 1E+10 colony forming unit/g.

In some embodiments, provided herein are frozen-direct vat set (F-DVS) or freeze-dried vat set (FD-DVS) starter culture compositions comprising lactic acid bacteria with manganese transporter for fermenting a food product and for inhibiting or delaying growth of fungi in said food product, characterized in that the composition comprises up to 600 ppm of manganese and wherein the concentration of the lactic acid bacteria is of at least 1E+10 colony forming unit/g.

Preferably, the concentration of the bacteria in the starter culture composition is at least 1E+10 colony forming units (CFU)/g.

To combat the problem of microbial spoilage, the present invention provides in further aspects a bacterial starter composition with at least 1E+10 CFU/g for inhibiting or delaying growth of fungi in a food product, characterized in that the composition comprises up to 600 ppm manganese. Preferably, the bacterial composition is a freeze-dried direct vat set (FD-DVS) or a frozen-direct vat set (F-DVS). The composition preferably comprises one or more lactic acid bacterial strains.

Provided herein is also a starter culture composition for inhibiting or delaying growth of fungi in a milk-based product or a starter culture composition for fermenting a milk-based food product and inhibiting or delaying growth of fungi in said food product, the composition comprising lactic acid bacteria, characterized in that the composition comprises up to 600 ppm of manganese and wherein the concentration of the lactic acid bacteria colony forming unit/g of is of at least 1E+10, preferably wherein the lactic acid bacterium ferments milk, wine, tea, plant and/or meat matrix.

The composition, preferably a freeze-dried DVS (FD-DVS) or frozen DVS (F-DVS), may comprise up to 550 ppm of manganese, up to 500 ppm of manganese, up to 450 ppm of manganese, up to 400 ppm of manganese, up to 350 ppm of manganese, up to 300 ppm of manganese, up to 250 ppm of manganese, up to 200 ppm of manganese, up to 150 ppm of manganese, up to 100 ppm of manganese, up to 70 ppm of manganese, up to 50 ppm of manganese, up to 40 ppm of manganese.

The composition may comprise 10-600 ppm of manganese, 30-600 ppm of manganese, 35-600 ppm of manganese, 40-600 ppm of manganese, 45-600 ppm of manganese, 50-600 ppm of manganese, 60-550 ppm of manganese, 100-500 ppm of manganese, 150-450 ppm of manganese, 190-400 ppm of manganese, 200-350 ppm of manganese, 250-300 ppm of manganese. Preferably, the composition may comprise 40-250 ppm of manganese, more preferably the composition may comprise 45-200 ppm of manganese.

The composition may comprise a lactic acid bacterium having a colony forming unit/g of cells of 1E+10-5E+12, preferably 2.0E+10-6.5E+11, more preferably 6.0E+10-6.4E+11, even more preferably 1.3E+11-5.6E+11.

In a preferred embodiment, the composition now disclosed may be a freeze-dried vat set (FD-DVS) or a frozen-direct vat set (F-DVS), in particular the composition may be a freeze-dried direct vat set (FD-DVS) containing an additive or a cryoprotectant agent free or substantially free of manganese or the composition may be a frozen direct vat set (F-DVS) containing an additive or a cryoprotectant agent free of manganese or substantially free of manganese. Preferably, the composition is a freeze-dried direct vat set (FD-DVS) and it may further comprise an additive (or cryoprotective agent) selected from: sodium caseinate, inositol, monosodium glutamate, sodium ascorbate, sucrose, maltodextrin, inosine monophosphate (IMP), inosine, polysorbate 80, glutamic acid, lysine, Na-glutamate, malt extract, whey powder, yeast extract, gluten, collagen, gelatin, elastin, keratin, albumin, carbohydrate, or mixtures thereof. Preferably the additive (or cryoprotective agent) is free of manganese or substantially free of manganese.

The composition may additionally contain as further components cryoprotectants and/or conventional additives including nutrients such as yeast extracts, sugars and vitamins, e.g. vitamin A, C, D, K or vitamins of the vitamin B family. Suitable cryoprotectants that may be added to the compositions of the invention are components that improve the cold tolerance of the microorganisms, such as mannitol, sorbitol, sodium tripolyphosphate, xylitol, glycerol, raffinose, maltodextrin, erythritol, threitol, trehalose, glucose and fructose. Other additives to may include, e.g., carbohydrates, flavors, minerals, enzymes (e.g. rennet, lactase and/or phospholipase).

In an embodiment, the composition may be a frozen direct vat set (F-DVS) containing an additive or a cryoprotectant agent free of manganese or substantially free of manganese, in a concentration of 10-40% weight of cryoprotectant per weight of the F-DVS form or 20-35% weight of cryoprotectant per weight of the F-DVS form, such as 31% weight of cryoprotectant per weight of the F-DVS form.

In a preferred embodiment, the composition is a freeze-dried vat set (FD-DVS) comprising a carbohydrate as an additive, preferably wherein the additive (or cryoprotective agent) is free of manganese. Suitable examples include the ones selected from the group consisting pentoses (eg. ribose, xylose), hexoses (eg. fructose, mannose, sorbose), disaccharides (eg. ducrose, drehalose, melibiose, lactulose), oligosaccharides (eg. raffinose), oligofrutoses (eg. actilight, fribroloses), polysaccharides (eg. maltodextrins, xanthan gum, pectin, alginate, microcrystalline cellulose, dextran, polyethylene glycol, and sugar alcohols (sorbitol, manitol). The preferred carbohydrate is a disaccharide preferably trehalose, sucrose, and/or maltodextrin.

In a preferred embodiment, the composition, when in a frozen state, may comprise from 2% to 70% of an additive (or cryoprotective agent) measured as weight of additive per weight of DVS form, more preferably from 3% to 50% of additive (or cryoprotective agent) measured as weight of additive per weight of DVS form, even more preferably from 4% to 40% of additive (or cryoprotective agent) measured as weight of additive per weight of DVS form and most preferably from 10% to 35% of additive (or cryoprotective agent) measured as weight of additive per weight of DVS form. Preferably the additive is free of manganese or substantially free of manganese.

In the context of the present invention, the additive or cryoprotectant is free of manganese or substantially free of manganese when a concentration of less than 10 ppm of manganese is present in said additive or cryoprotectant. Furthermore, in the context of this invention, “additive”, “cryoprotectant” or “cryoprotectant agent” are used interchangeable.

The addition of the additive (or cryoprotective agent) to the, after fermentation, isolated viable bacteria (biomass) may be done by mixing solid cryoprotective agent with the biomass for e.g. 30 minutes at a suitable temperature. If the cryoprotective agent is e.g. sucrose a suitable temperature may be room temperature. Alternatively, a sterile solution of the additive (or cryoprotective agent) may be mixed with the biomass. For sucrose suitable sterile solutions may be made from a 50% (w/w) sucrose solution. For trehalose suitable sterile solutions may be made from a 40% (w/w) solution.

In a preferred embodiment, the composition is a freeze-dried DVS comprising 10-600 ppm of manganese, 30-600 ppm of manganese, 35-600 ppm of manganese, 40-600 ppm of manganese, 45-600 ppm of manganese, 50-600 ppm of manganese, 60-550 ppm of manganese, 100-500 ppm of manganese, 150-450 ppm of manganese, 190-400 ppm of manganese, 200-350 ppm of manganese, 250-300 ppm of manganese.

Preferably, the composition is a freeze-dried DVS comprising 40-250 ppm of manganese, more preferably the composition is a freeze-dried DVS comprising 45-200 ppm of manganese. Furthermore, said preferred freeze-dried DVS composition may comprise a lactic acid bacterium is selected from a group consisting of Lactobacillus plantarum, Lactobacillus fermentum, Lactobacillus reuteri, Lactobacillus sakei, Lactobacillus brevis, Lactobacillus casei, Lactobacillus paracasei, Lactobacillus salivarius, Lactobacillus alimentarius, Pediococcus acidilactici, Lactobacillus rhamnosus and Lactobacillus kefiri, preferably selected from Lactobacillus paracasei and/or Lactobacillus rhamnosus, wherein the lactic acid bacterium has a CFU/g of at least 1E+10, including 2E+10, 3E+10, 4E+10, 5E+10, 6E+10, 7E+10, 8E+10, 9E+10 CFU per g, such as 2.0E+10-6.5E+11, preferably 6.0E+10-6.4E+11, more preferably 1.3E+11-5.6E+11, and/or wherein the freeze-dried DVS has an additive or cryoprotectant agent free of manganese or substantially free of manganese and in a concentration of 10-30% dry weight of cryoprotectant per weight of the FD-DVS form or 20-30% dry weight of cryoprotectant per weight of the FD-DVS form, such as 27% dry weight of cryoprotectant per weight of the FD-DVS form.

In a preferred embodiment, the present invention may provide a composition for inhibiting or delaying growth of fungi in a food product or a composition for inhibiting or delaying growth of fungi in a milk-based product or a composition for fermenting a milk-based food product and inhibiting or delaying growth of fungi in said food product, wherein the lactic acid bacterium comprises a manganese transporter having at least 55%, such as at least 60%, 65%, 70%, 75%, 80%, 85%, 90%, 95%, 96%, 97%, 98%, 99% or 100% sequence identity with the sequence of any one of SEQ ID NO: 1-3.

In a preferred embodiment, the present invention may provide a composition for inhibiting or delaying growth of fungi in a food product or a composition for inhibiting or delaying growth of fungi in a milk-based product or a composition for fermenting a milk-based food product and inhibiting or delaying growth of fungi in said food product, wherein the lactic acid bacterium is free of a superoxide dismutase, preferably free of a manganese superoxide dismutase.

Superoxide dismutases, such as manganese superoxide dismutase, have been studied and are for example described in Kehres et al., “Emerging themes in manganese transport, biochemistry and pathogenesis in bacteria.” FEMS microbiology reviews 27.2-3 (2003): 263-290; Culotta V. O “Superoxide dismutase, oxidative stress, and cell metabolism” Curr. Top. Cell Regul. 36, 117-132 (2000) or Whittaker J. W “Manganese superoxide dismutase” Met. Ions Biol. Syst. 37, 587-611 (2000), among others.

In the context of the present invention, the term “free of” means that genome of the one or more bacteria strains do not present a gene coding for a superoxide dismutase, or even if the genome of the one or more bacteria strains presents a gene coding for a superoxide dismutase, this gene is not express by the one or more bacteria strains.

In a preferred embodiment, the present invention may provide a composition for inhibiting or delaying growth of fungi in a food product or a composition for inhibiting or delaying growth of fungi in a milk-based product or a composition for fermenting a milk-based food product and inhibiting or delaying growth of fungi in said food product, wherein the lactic acid bacterium is selected from a group consisting of Lactobacillus plantarum, Lactobacillus fermentum, Lactobacillus reuteri, Lactobacillus sakei, Lactobacillus brevis, Lactobacillus casei, Lactobacillus paracasei, Lactobacillus salivarius, Lactobacillus alimentarius, Pediococcus acidilactici, Lactobacillus rhamnosus and Lactobacillus kefiri.

In a preferred embodiment, the present invention may provide a composition for inhibiting or delaying growth of fungi in a food product or a composition for inhibiting or delaying growth of fungi in a milk-based product or a composition for fermenting a milk-based food product and inhibiting or delaying growth of fungi in said food product, wherein the fungi is yeast and/or mold, preferably wherein the fungi is a yeast selected from the group consisting of Torulaspora spp., Cryptococcus spp., Saccharomyces spp., Yarrowia spp., Debaryomyces spp., Candida spp. and Rhodoturola, preferably wherein Debaromyces spp. is Debaromyces hansenii and/or wherein the fungi is a mold selected from the group consisting of Aspergillus spp., Cladosporium spp., Didymella spp. or Penicillium spp. preferably wherein Penicillium spp. is Penicillium crustosum, Penicillium paneum, Penicillium carneum or Penicillium roqueforti.

In a further aspect, the present invention also provides a food product comprising the composition herein disclosed. In an embodiment, the food product may be a fermented food product, preferably a thermophilic fermented food product or a mesophilic fermented food product, more preferably said food product may be yogurt or cheese.

In a third aspect, the present invention also provides the use of the composition herein disclosed as an inhibitor of growth of fungi in a food product, preferably wherein the food product is a fermented food product, more preferably a thermophilic fermented food product or a mesophilic fermented food product, more preferably yogurt or cheese.

### BRIEF DESCRIPTION OF THE FIGURES

FIG. 1: Yogurt (1.5% fat) produced with a starter culture (reference), or produced with a starter culture and with a F-DVS form of L. rhamnosus strain 1 (1E+7 CFU/g), wherein said F-DVS form has about 30 ppm of manganese, or about 195 ppm of manganese, or about 625 ppm of manganese, or produced with a starter culture and a FD-DVS form of L. paracasei and L. rhamnosus strain 3, wherein said form of FD-DVS form has about 275 ppm of manganese. The yogurt was spiked with Penicillium (P.) crustosum (X), P. carneum (Y) and P. roqueforti (Z) (500 spores/each) and stored at 22° C. for 7 days.

FIG. 2: Growth of Torulaspora (T.) delbrueckii when 50 CFU/g of T. delbrueckii is used to inoculate a yogurt (1.5% fat) produced with a starter culture (reference), or produced with a starter culture and with a F-DVS form of L. rhamnosus strain 1 (1E+7 CFU/g), wherein said F-DVS form has about 30 ppm of manganese, or about 195 ppm of manganese, or about 625 ppm of manganese. The yogurt was stored at 7° C. for 23 days.

FIG. 3: Growth of Debaryomyces (D.) hansenii when 50 CFU/g of D. hansenii is used to inoculate a yogurt (1.5% fat) produced with a starter culture (reference), or produced with a starter culture and with a F-DVS form of L. rhamnosus strain 1 (1E+7 CFU/g), wherein said F-DVS form has about 30 ppm of manganese, or about 195 ppm of manganese, or about 625 ppm of manganese. The yogurt was stored at 7° C. for 23 days.

FIG. 4: Growth of D. hansenii when 50 CFU/g of D. hansenii is used to inoculate a yogurt (1.5% fat) produced with a starter culture (reference), or produced with a starter culture and with a F-DVS form of L. rhamnosus strain 2, wherein said F-DVS form has about 45 ppm of manganese, or with a starter culture and with a F-DVS form of L. rhamnosus strains 1 and 2, wherein the F-DVS form has about 65 ppm of manganese, or produced with a starter culture and a FD-DVS form of benchmark composition A having about 845 ppm of manganese, or produced with a starter culture and a FD-DVS form of benchmark composition B having about 630 ppm of manganese, or produced with a starter culture and a FD-DVS form of benchmark composition C having 870 ppm of manganese. The yogurt was stored 32 days at 7° C.

FIG. 5: Yogurt (1.5% fat) produced with a starter culture (reference), or produced with a starter culture and with a F-DVS form of L. rhamnosus strain 2 (1E+7 CFU/g) wherein the F-DVS form has about 45 ppm of manganese, or with a F-DVS form of L. rhamnosus strains 1 and 2 (1E+7 CFU/g) wherein the F-DVS form has about 65 ppm of manganese, or with a FD-DVS form of benchmark composition A (1E+7 CFU/g) having about 845 ppm of manganese, or with a FD-DVS form of benchmark composition B (1E+7 CFU/g) having about 630 ppm of manganese, or with a FD-DVS form of benchmark composition C (1E+7 CFU/g) having about 870 ppm of manganese. The yogurt was spiked with P. carneum, P. paneum and P. roqueforti (500 spores/each) and stored at 7° C. for 24 days (upper row) or stored at 25° C. for 6 days (lower row). The arrangement of the Penicillium species, on the plate, is identical to FIG. 1 except that P. carneum was replaced by P. paneum.

FIG. 6: Growth of D. hansenii when 50 CFU/g of D. hansenii is used to inoculate a yogurt (1.5% fat) produced with a starter culture (reference), or produced with a starter culture and FD-DVS form of L. paracasei and L. rhamnosus strain 3, wherein said form of FD-DVS form has about 275 ppm of manganese, or produced with a starter culture and with a FD-DVS form of L. rhamnosus strain 2 (1E+7 CFU/g), wherein said FD-DVS form has about 200 ppm of manganese and to which skimmed milk powder (SMP) was added or not to the cryoprotectant (standard cryo) used to obtain the FD-DVS form. The yogurt was stored at 7° C. for 27 days.

FIG. 7: Yogurt (1.5% fat) produced with a starter culture and with a FD-DVS form of L. rhamnosus strain 2 (1E+7 CFU/g), wherein said FD-DVS form has about 200 ppm of manganese and to which different concentrations of manganese (1, 5, 10, 20 and 40 ppm) were added to the cryoprotectant used to obtain the FD-DVS form. The yogurt was spiked with P. crustosum, P. carneum and P. roqueforti (500 spores/each) and stored at 22° C. for 12 days. The arrangement of the Penicillium species, on the plate, is identical to FIG. 1.

FIG. 8: Growth of D. hansenii when 50 CFU/g of D. hansenii is used to inoculate a yogurt (1.5% fat) produced with a starter culture and with a FD-DVS form of L. rhamnosus strain 2 (1E+7 CFU/g), wherein said FD-DVS form has about 200 ppm of manganese to which different concentrations of manganese (1 and 40 ppm) were added to the cryoprotectant used to obtain the FD-DVS form. The yogurt was stored at 7° C. for 27 days.

### DETAILED DISCLOSURE OF THE INVENTION

Food loss is a major concern worldwide—approximately one third of all food produced for human consumption is either lost or wasted. The reasons for this massive global food loss are diverse, but microbial spoilage that affects organoleptic product quality (appearance, texture, taste, and aroma), plays a major role. Since fungi can grow in different and even harsh environments, they are the major spoilage microorganisms found at all stages of the food process chain. It is therefore crucial to reduce food losses by controlling fungal contamination.

In response to this demand, the present invention provides a novel composition for inhibiting or delaying fungal growth in a food product. Manganese is present in trace amounts in nature and many of our consumer goods. It is recently discovered that low levels free manganese concentrations can serve as limiting factor for yeast and/or mold growth. Therefore, by manipulating the concentration of free manganese in a given product, microbial spoilage could be effectively managed. Such spoilage prevention strategy is applicable even beyond food products and extending to other products which are generally prone to microbial contamination, such as feed products, biologic products, health care products, pharmaceutical products and the like.

Many bacteria have developed sophisticated acquisition system to scavenge essential metals from the environment. It is therefore possible to apply manganese scavenging bacteria to take up free manganese in the product. The present inventors have moreover recently discovered that when preparing the bacteria in upscaling process, lower level of manganese is preferred.

The present invention provides in a first aspect a starter culture composition for inhibiting or delaying growth of fungi in a milk-based product or a starter culture composition for fermenting a milk-based food product and inhibiting or delaying growth of fungi in said food product, the composition comprising lactic acid bacteria, characterized in that the composition comprises up to 600 ppm of manganese and wherein the concentration of the lactic acid bacteria colony forming unit/g of is of at least 1E+10, preferably wherein the lactic acid bacterium ferments milk, wine, tea, plant and/or meat matrix.

In general, inhibiting means a decrease, whether partial or whole, in function and activity of cells or microorganisms. As used herein, the terms “to inhibit” and “inhibiting” in relation to yeasts and molds mean that the growth, the number, or the concentration of yeasts and molds is the same or reduced. This can be measured by any methods known in the field of microbiology. Inhibition can be observed by comparing the fungal growth, number or concentration in or on a product to a control. The control can be the same product but without the composition.

In general, the term “to delay” means the act of stopping, postponing, hindering, or causing something to occur more slowly than normal. As used herein, “delaying growth of fungi” refers to the act of postponing the growth of fungi. This can be observed by comparing the time needed for the fungi to grow to a given level in two products, one of which with the composition as disclosed and the other one without.

In some embodiments, “inhibiting or delaying growth of fungi” refers to delaying by 7 days, such as 8, 9, 10, 11, 12, 13, 14, 15, 16, 17, 18, 20, 21, 22, 23, 24, 25, 30, 35, 40, 45, 50, 55, 60 days.

The term “antifungal” is to be understood in the present application as the ability to inhibit delaying growth of fungi in a food product such as milk-based product.

As used herein, the term “food matrix” refers to the food's composition and structure. It is based on the concept that nutrients are contained in a continuous medium.

As used herein, the term “meat matrix” refers to the meat's composition and structure. It is based on the concept that nutrients are contained in a continuous medium.

Manganese

Manganese is involved in many crucial biological processes and is ubiquitously found in all organisms. Manganese also contributes to protection against oxidative stress and can also contribute to the catalytic detoxification of reactive oxygen species. Many bacteria have developed sophisticated acquisition system to scavenge essential metals from the environment, using low and high affinity transport systems for chelated or free metals. Manganese which is taken up by bacteria forms a large complex of nondialyzable polyphosphate-protein aggregates in the protein which may reach very high intracellular concentrations.

“Manganese” in accordance with the present application refers to manganese which is present in a composition for inhibiting or delaying growth of fungi in a food product. In the context of the present invention, “manganese” includes the manganese which is found intracellularly and extracellularly.

As used herein, the term “bacteria strain” has its common meaning in the field of microbiology and refers to a genetic variant of a bacterium.

Manganese concentration or manganese level as used herein is expressed in parts per million (“ppm”) calculated on a weight/weight basis. Having manganese in a product or composition to a concentration below a value means having manganese in the product or parts thereof such that the concentration of manganese in the entire product or entire composition by weight is below a given value. Methods of determining trace elements such as manganese are known in the art and described for example in Nielsen, S. Suzanne, ed. Food analysis. Vol. 86. Gaithersburg, Md.: Aspen Publishers, 1998.

Methods of measuring of manganese at low concentration are well known to a person skilled in the art. Such methods include atomic absorption spectroscopy, atomic emission spectroscopy, mass spectrometry, neutron activation analysis and x-ray fluorimetry (see e.g., Williams et al. “Toxicological profile for manganese.” (2012)).

Preferably, manganese concentration is measured according the standard procedure as described in “Foodstuffs—Determination of trace elements—Pressure digestion” in European Standard EN13805:2014 published by European Committee for Standardization or as described in “Water quality—Determination of selected elements by inductively coupled plasma optical emission spectrometry (ICP-OES)” in ISO 11885:2007 published by International Organization for Standardization.

Manganese levels present in the final composition, either a F-DVS product or a FD-DVS product, was identified to be one of the main parameters affecting the anti-fungal activity of the strains, with high levels of Mn giving less anti-fungal activity and low levels giving high anti-fungal activity.

Cadmium and manganese uptake genes from Lactobacillus plantarum have been studied previously. In this, Hao et al. disclosed two cadmium uptake systems in Lactobacillus plantarum ATCC14917. One is independent of Mn²⁺ starvation but has low affinity, while the other is with high affinity and induced by Mn²⁺ starvation but inhibited in presence of Mn²⁺. For the latter, Mn²⁺ and Cd²⁺ are competitive inhibitors of each other, and its affinity for Cd²⁺ is higher than that for Mn²⁺ (Hao et al. “Cloning, expression, and characterization of cadmium and manganese uptake genes from Lactobacillus plantarum.” Applied and Environmental Microbiology 65.11 (1999): 4746-4752 and Hao et al “Characterization of cadmium uptake in Lactobacillus plantarum and isolation of cadmium and manganese uptake mutants.” Applied and environmental microbiology 65.11 (1999): 4741-4745.). The papers are not related to high biomass cell culture for direct inoculation. Neither do they teach nor suggest the findings of the present application.

A skilled person in the art is able to adjust the manganese level in the media to obtain a final product containing the desired manganese level. For example, if the manganese level in the growth media is low, then the final composition would accordingly have a low level of manganese, since manganese is expected to be retained in the concentration process. On the other hand, if the manganese level in the growth media is high, then the final composition would have accordingly a high level of manganese.

Fungus

A fungus is a member belonging to the kingdom of fungi. Fungal growth can be measured with various methods known to a skilled person in the art. For example, fungal growth can be measured by density or size of colony, cell number, mycelial mass changes, spore production, hyphal growth, colony-forming units (CFU) and the like, depending on the fungus type and the product to which the method is applied. Fungal growth can also be observed by measuring the change in nutrient or metabolite concentrations, such as carbon dioxide release and oxygen uptake.

The terms “inhibition of fungal growth” or “inhibiting growth of fungi” refer to the inhibition of fungal cell proliferation.

The terms “delay of fungal growth” or “delaying growth of fungi” refer to the slowing down of fungal cell proliferation. This can be observed for example, by measuring the fungal growth and comparing it with a control. Such control may be for example a product prepared without the composition now disclosed. Methods of determining fungal growth inhibition or delay are known to a skilled person in the art.

In one embodiment, the composition now disclosed inhibits the growth of yeast, such as Candida spp., Meyerozyma spp., Kluyveromyces spp., Pichia spp., Galactomyces spp., Trichosporon spp., Sporidiobolus spp., Torulaspora spp., Cryptococcus spp., Sacharomyces spp., Yarrowia spp., Debaryomyces spp., and Rhodoturola spp. Preferably, the fungi is a yeast selected from the group consisting of Torulaspora spp., Cryptococcus spp., Sacharomyces spp., Yarrowia spp., Debaryomyces spp., Candida spp. and Rhodoturola spp. More preferably, the fungus is a yeast selected from the group consisting of Torulaspora delbrueckii, Cryptococcus fragicola, Sacharomyces cerevisiae, Yarrowia lipolytica, Debaryomyces hansenii and Rhodoturola mucilaginosa.

In one embodiment, the composition now disclosed inhibits the growth of mold. Preferably, the fungus is a mold selected from the group consisting of Aspergillus spp., Cladosporium spp., Didymella spp. or Penicillium spp. More preferably, the fungus is a mold selected from the group consisting of Penicillium brevicompactum, Penicillium crustosum, Penicillium solitum, Penicillium carneum, Penicillium paneum, and Penicillium roqueforti.

Lactic Acid Bacterium (LAB)

“Lactic acid bacterium” designates a Gram-positive, microaerophilic or anaerobic bacterium, which ferments sugars with the production of acids including lactic acid as the predominantly produced acid. The food product typically has a pH of about 3.5 to about 6.5, such as about 4 to about 6, such as about 4.5 to about 5.5, such as about 5.

In a preferred embodiment, the composition now disclosed may comprise lactic acid bacteria having transport systems for manganese. These transport system for manganese have been studied and are for example described in Kehres et al., “Emerging themes in manganese transport, biochemistry and pathogenesis in bacteria.” FEMS microbiology reviews 27.2-3 (2003): 263-290.

A lactic acid bacterium strain useful for the present application has manganese uptake activities. With routine experiments a skilled person in the art is able of selecting bacteria with manganese uptake activities. Such bacteria may for example comprise bacterial Mn²⁺ transporters. Mn²⁺ transporters may be an ABC transporter (for example SitABCD and YfeABCD) or a proton-dependent Nramp-related transport system belonging to the family designated as TC #3.A.1.15 and TC #2.A.55 in the transporter classification system given by the Transport Classification Database (M. Saier; U of C A, San Diego, Saier M H, Reddy V S, Tamang D G, Vastermark A. (2014)). The TC system is a classification system for transport proteins which is analogous to the Enzyme Commission (EC) system for classification of enzymes. The transporter classification (TC) system is an approved system of nomenclature for transport protein classification by the International Union of Biochemistry and Molecular Biology. TCDB is freely accessible at http://www.tcdb.org which provides several different methods for accessing the data, including step-by-step access to hierarchical classification, direct search by sequence or TC number and full-text searching.

In a preferred embodiment, the lactic acid bacteria strain may comprise a protein belong to the family designated as TC #3.A.1.15 (manganese chelate uptake transporter (MZT) family) or TC #3.A.1.15.6, TC #3.A.1.15.8, TC #3.A.1.15.14 or functional variants thereof.

While the ABC transporter is mainly active at higher pH, proton driven transporters may be more active under acidic conditions. Thus, in one embodiment, the composition now disclosed may comprise a bacteria strain comprising a protein belong to the family designated as TC #2.A.55 (the metal ion (Mn²⁺-iron) transporter (Nramp) family) or a functional variant thereof. More preferably, the transporter belongs to the subfamily designated as TC #2.A.55.2 or the subfamily designated as TC #2.A.55.3.

For example, the composition herein disclosed may comprise lactic acid bacteria having a metal ion (Mn²⁺-iron) transporter (Nramp) designated as TC #2.A.55.3.1, TC #2.A.55.3.2, TC #2.A.55.3.2, TC #2.A.55.3.3, TC #2.A.55.3.4, TC #2.A.55.3.5, TC #2.A.55.3.6, TC #2.A.55.3.7, TC #2.A.55.3.8 or TC #2.A.55.3.9 or functional variants thereof, preferably having TC #2.A.55.2.6 or functional variants thereof.

The term “functional variant” is a protein variant having a substantially similar biological activity, i.e. manganese uptake activities.

As used herein, a “variant” refers to a variant form of a protein which shares at least 55%, 60%, 65%, 70%, 75%, 80%, 85%, 90%, 95%, 96%, 97%, 98%, 99% or 100% sequence identity with a particular nucleic acid or amino acid sequence of the protein.

The present disclosure additionally provides polypeptide sequences of manganese transporters that may be present in the lactic acid to carry out the present invention.

In a preferred embodiment, the lactic acid bacteria strain comprising a polypeptide having the sequence of SEQ ID NO: 1 (MASEDKKSKREHIIHFEDTPSKSLDEVNGSVEVPHNAGFWKTLAAYTGPGILVAVGYMDPGNWI TSIAGGASFKYSLLSVILISSLIAMLLQAMAARLGIVTGRDLAQMTRDHTSKAMGGFLWVITELAI MATDIAEIIGSAIALKLLFNMPLIVGIIITTADVLILLLLMRLGFRKIEAVVATLVLVILLVFAYEVILAQ PNVPELLKGYLPHADIVTNKSMLYLSLGIVGATVMPHDLFLGSSISQTRKIDRTKHEEVKKAIKFST IDSNLQLTMAFIVNSLLLILGAALFFGTSSSVGRFVDLFNALSNSQIVGAIASPMLSMLFAVALLAS GQSSTITGTLAGQIIMEGFIHLKMPLWAQRLLTRLMSVTPVLIFAIYYHGNEAKIENLLTFSQVFLSI ALPFAVIPLVLYTSDKKIMGEFANRAWVKWTAWFISGVLIILNLYLIAQTLGFVK) or functional variants thereof.

In other preferred embodiments, the lactic acid bacteria strain comprises a polypeptide having at least 55%, such as at least 60%, 65%, 70%, 75%, 80%, 85%, 90%, 95%, 96%, 97%, 98%, 99% or 100% sequence identity with the sequence of SEQ ID NO: 1.

Table 1 shows exemplary sequences which encodes functional variants of SEQ ID NO: 1 and their sequence identity with SEQ ID NO: 1.

TABLE 1

| | SEQ | | | |
|---|---|---|---|---|
| | ID | | % | |
| Origin | NO | Protein ID | identity | Sequence |
| Lactobacillus | 4 | WP_013245308 | 99.8 | MASEDKKSKREHIIHFEDTPSKSLDEV |
| casei | | .1 | | NGSVEVPHNAGFWKTLAAYTVPGILV |
| | | | | AVGYMDPGNWITSIAGGASFKYSLLS |
| | | | | VILISSLIAMLLQAMAARLGIVTGRDLA |
| | | | | QMTRDHTSKAMGGFLWVITELAIMAT |
| | | | | DIAEIIGSAIALKLLFNMPLIVGIIITTAD |
| | | | | VLILLLLMRLGFRKIEAVVATLVLVILLV |
| | | | | FAYEVILAQPNVPELLKGYLPHADIVTN |
| | | | | KSMLYLSLGIVGATVMPHDLFLGSSIS |
| | | | | QTRKIDRTKHEEVKKAIKFSTIDSNLQ |
| | | | | LTMAFIVNSLLLILGAALFFGTSSSVGR |
| | | | | FVDLFNALSNSQIVGAIASPMLSMLFA |
| | | | | VALLASGQSSTITGTLAGQIIMEGFIHL |
| | | | | KMPLWAQRLLTRLMSVTPVLIFAIYYH |
| | | | | GNEAKIENLLTFSQVFLSIALPFAVIPLV |
| | | | | LYTSDKKIMGEFANRAWVKWTAWFIS |
| | | | | GVLIILNLYLIAQTLGFVK |
| Lactobacillus | 5 | WP_011667125 | 76.5 | MKNHETDTKTKHHMIESTGSGQKSLD |
| brevis | | .1 | | EVNGTVEVPQNAGFWRTLMAYTGPGA |
| | | | | LIAVGYMDPGNWITSIAGGAQYKYTLL |
| | | | | TVVLLSSLVAMLLQAMSARLGIVTGKD |
| | | | | LAQLTREHTGKRTGFALWIITELAIMAT |
| | | | | DIAEIIGSAIALKLLFGFPLIVGIIITAMD |
| | | | | VLVLLVLMKLGFRKIEAIVATLVAVILFV |
| | | | | FLYEVILAQPHMGEVLKGYLPSSTVVT |
| | | | | NHGMLYLSLGIVGATVMPHDLYLGSSI |
| | | | | SQTRSFDRKNRKSVAQAIKFTTIDSNI |
| | | | | QLTLAFVVNSLLLILGAALFFGTNSDLG |
| | | | | RFVDLFNALSDSQIVGAIASPMLSMLF |
| | | | | ALALLSSGQSSTITGTLAGQIIMEGFIN |
| | | | | LKMPLWAQRLITRLLSVTPVIIFAIIYHG |
| | | | | NEAKIEDLLTFSQVFLSIALPFAMIPLVI |
| | | | | FTSSKKLMGEFANRTWSKILGWIIAVI |
| | | | | LIILNIYLILNTLHIVQ |
| Pediococcus | 6 | WP_070366435 | 76.4 | MSKKLDEVDNKSLDEINGSIKVPKNA |
| acidilactici | | .1 | | GFFKTLMAYTGPGILIAVGYMDPGNWI |
| | | | | TSIAGGAQFKYTLLSVVLISSLIAMLLQ |
| | | | | AMSARLGIVTGKDLAQLTRERTSKRV |
| | | | | GFMLWVVAELAIMATDIAEIIGSGIALE |
| | | | | LLFHIPLIIGILITAADVLILLLLMRLGFR |
| | | | | KIEAIVATLVMVILIVFAYEVFLSDPSIS |
| | | | | GIIKGYVPAPVILQNNSMLYLSLGIVGA |
| | | | | TVMPHDLYLGSSISQTREIDRRDRKNV |
| | | | | AQAIRFSTIDSNMQLFLAFIVNSLLLIL |
| | | | | GAALFYGTDSSLGRFVDLFNALSDNQI |
| | | | | VGAIASPMLSMLFAVALLASGQSSTIT |
| | | | | GTLSGQIIMEGFIRLRVPLWVQRLVTR |
| | | | | LLSVAPVLIFAIYYHGDEAKIENLLTFS |
| | | | | QVFLSVALPFAVIPLVMYTSSKKLMGE |
| | | | | FANRQWVKWCAWIATIILILLNIYLILQ |
| | | | | TLGIVK |
| Lactobacillus | 7 | YP_004888316. | 74.3 | MKSAKTKDHAKMKAAEEKAIHSTGAD |
| plantarum | | 1 | | SKSLDEVNGSVRVPKDASFWRTLIAYT |
| | | | | GPGALVAVGYMDPGNWITSIAGGSQY |
| | | | | KYALLSVILLSSLIAMLLQAMAARLGIV |
| | | | | TGKDLAQLTRERTSKGMGIFLWIITEL |
| | | | | AIMATDVAEIIGSGIALKLLFGFPLIVGI |
| | | | | LITTADVLILLLLMKLGFRKIEAIVATLV |
| | | | | AVILFVFLYEVIISQPNIPEMLKGYVPTS |
| | | | | RIVSNRSMLFLALGIVGATVMPHNLYL |
| | | | | GSSISQTRQVDRSDEKEVAKAVKFTTI |
| | | | | DSNIQLSVAFVVNSLLLILGAALFFGTK |
| | | | | GDLGRFVDLYNALGDSKVVGSIASPLL |
| | | | | SMLFAIALLSSGQSSTITGTLSGQIIME |
| | | | | GFIRLKMPLWAQRLLTRLISVTPVLAFA |
| | | | | IYYHGNEAKIEDLLTMSQVFLSIALPFA |
| | | | | MIPLVMFTSNRALMGNFTNRVWVKWT |
| | | | | AWIVTVILIILNIYLILQTVGLVK |
| Lactobacillus | 8 | WP_089535161 | 67.9 | MHYADGSSLEEINNTVAIPKNAGFWK |
| sakei | | .1 | | TLMAFMGPGALVAVGYMDPGNWITSI |
| | | | | AGGAQFAYTLISVILVSNLIAMLLQAM |
| | | | | AARLGIVTGMDLAQMTRAKTGKKMGI |
| | | | | FLWIVTELAIMATDIAEIIGSAIALELIF |
| | | | | NIPLLWGVLITAFDVLLLLLLMKLGFRK |
| | | | | IEAIVATLVAVILFVFLYEVILAQPNMG |
| | | | | DVVRGFVPSPRIMTDKKMLFLALGIVG |
| | | | | ATVMPHNLYLHSSIAQARQYDRDDVA |
| | | | | EKRKAIKFTVIDSNIQLTIAFVVNCLLLI |
| | | | | LGAAMFYGTNSDLGRFVDLFNALQNK |
| | | | | EIVGSIASPMLSLLFAVALLASGQNSTI |
| | | | | TGTLSGQIVMEGFVRMKIPLWARRVIT |
| | | | | RGLSILPVIIFTVYYHGNEAQVENLLIYS |
| | | | | QVFLSIALPVSMIPLTLFTSDEKIMGPF |
| | | | | VNRPWVKYTAWFVTIVLTLLNIYLILQT |
| | | | | VGLAA |
| Lactobacillus | 9 | WP_057737113 | 68.3 | MSSKNKKHESLIHYANGPSLEEINDTV |
| alimentarius | | .1 | | EIPKDAGFFKTLLAYSGPGALVAVGYM |
| | | | | DPGNWVTSIAGGAQFKYKLLSVILISS |
| | | | | LIAMLLQYMSAKLGIVTGRDLAQLTRD |
| | | | | RTSRVGGFILWIITELAIMATDIAEIIGS |
| | | | | AIALKLLFNIPVLWGVIITAFDVLLLLVL |
| | | | | MKLGFRKIEAIVATLIMVILLVFLYEVIL |
| | | | | AKPDVGQMMVGFIPEPKILQNQSMLY |
| | | | | LSLGIVGATVMPHNLYLHSSISQARKY |
| | | | | DRDDPKSIHQAVRFSTWDSNIQLTLA |
| | | | | FVVNTLLLLLGAALFYGTSSDLGRFVDL |
| | | | | FNALQDPKVAGAVASPVLSILFAVALL |
| | | | | ASGQNSTITGTLSGQIVMEGFIHMKM |
| | | | | KLWARRVITRLMSIIPVITFAIIYHGNE |
| | | | | AKIESLLTFSQVFLSVALPFSIFPLIKFT |
| | | | | SNKKLMGEFVNNKLVEYIGYFVAIVLTI |
| | | | | LNIWLIYTTFVPTA |
| Lactobacillus | 10 | WP_056974015 | 65.1 | MTKEETKLFHYADGPSLEEINGTVAVP |
| floricola | | .1 | | KKGGFWKTLFAFSGPGALVAVGYMDP |
| | | | | GNWVTSIAGGAQYQYTLLSVILISSLIA |
| | | | | MLLQAMSARLGIASGLDLAQATAKHS |
| | | | | PKWLRYTLWIITELAIMATDIAEIVGAA |
| | | | | IALKLLFNLPLIVGIFLTTLDVMLLLLLM |
| | | | | KLGFRKIEAIVGALIVSILVIFLYEVILAR |
| | | | | PDVGAMFAGYIPQPEVVTNKGAFYIAL |
| | | | | GIVGATVMPHNLYLHSSIAQARQYDR |
| | | | | NDIEEKKRAIKFTVLDSNIQLSVAFVV |
| | | | | NTLLLLLGAALFYGAQTDLGTFSELYNA |
| | | | | LQNPQVAGVIASPILSVLFAVALLASG |
| | | | | QNSTITGTLSGQIVMEGFIHLKMPMW |
| | | | | ARRVITRLISVIPVLIFAIIYHSNEAKIE |
| | | | | DLLVFSQVFLSIALPVSIIPLVMFTANK |
| | | | | KIMGPFVNKKWVTITSSLVAIILTGLNI |
| | | | | FLILQTLGWVQ |
| Lactobacillus | 11 | WP_011667396 | 57.6 | MTDNVSAKSVQGDLTNGPSLAEINGS |
| brevis | | .1 | | VRVPKEKGFVRNLLAFSGPGALVAVGY |
| | | | | MDPGNWV |
| | | | | TSIGGGAQYGYLLMSVILMSSLIAMLL |
| | | | | QYMAAKLGIVTQMDLARATRAHTGKR |
| | | | | IGAVLWV |
| | | | | MTELAIMATDIAEVIGGAIALKLLFGVP |
| | | | | LILGVSLTVLDVLLLLLLTRLGFRKIEAI |
| | | | | VLC |
| | | | | LILVILVVFAYEVVIAQPSMGQAVASFV |
| | | | | PQAEIMRPGQLTMALGIVGATVMPHN |
| | | | | LYLHSS |
| | | | | IAQTRKFDRQDPAEMARAVKFTAWDS |
| | | | | NIQLFGAFIINCLLLLLGAAMFFGKDAG |
| | | | | ALGTFG |
| | | | | QLYDALQDNRLAGAVASPVLSTLFAVA |
| | | | | LLASGQNSTITGTLTGQVIMEGFINMR |
| | | | | LPIWVR |
| | | | | RLVTRLISVAPVIIVTILYGGSEQALDR |
| | | | | LLVNSQVFLSIALPFSMIPLTIFTSSKRI |
| | | | | MGT |
| | | | | RWVNRWWVTALAWGCTAILTVLNIQI |
| | | | | VWATMTTLF |

In a preferred embodiment, the lactic acid bacteria strain comprises a polypeptide having the sequence of SEQ ID NO: 2 (MARPDERLTVQREKRSLDDINRSVQVPSVYESSFFQKFLAYSGPGALVAVGYMDPGNWLTALEG GSRYHYALLSVLLMSILVAMFMQTLAIKLGVVARLDLAQAIAAFIPNWSRICLWLINEAAMMATDM TGVVGTAIALKLLFGLPLMWGMLLTIADVLVVLLFLRFGIRRIELIVLVSILTVGIIFGIEVARADPSI GGIAGGFVPHTDILTNHGMLLLSLGIMGATIMPHNIYLHSSLAQSRKYDEHIPAQVTEALRFGKW DSNVHLVAAFLINALLLILGAALFYGVGGHVTAFQGAYNGLKNPMIVGGLASPLMSTLFAFALLITG LISSIASTLAGQIVMEGYLNIRMPLWERRLLTRLVTLIPIMVIGFMIGFSEHNFEQVIVYAQVSLSIA LPFTLFPLVALTNRRDLMGIHVNSQLVRWVGYFLTGVITVLNIQLAISVFV) or functional variants thereof.

In other preferred embodiments, the lactic acid bacteria strain comprises a polypeptide having at least 55%, such as at least 60%, 65%, 70%, 75%, 80%, 85%, 90%, 95%, 96%, 97%, 98%, 99% or 100% sequence identity with the sequence of SEQ ID NO: 2.

Table 2 shows exemplary sequences which encode functional variants of SEQ ID NO: 2 and their sequence identity with SEQ ID NO: 2.

TABLE 2

| | SEQ | | | |
|---|---|---|---|---|
| | ID | Protein | % | |
| Origin | NO | ID | identity | Sequence |
| Lactobacillus | 12 | WP_0124917 | 99.3 | MARPDERLTVQREKRSLDDINRSVQVP |
| casei | | 67.1 | | SVYESSFFQKFLAYSGPGALVAVGYMDP |
| | | | | GNWLTALEGGSRYHYALLSVLLMSILVA |
| | | | | MFMQTLAIKLGVVARLDLAQAIAAFIPH |
| | | | | WSRICLWLINEAAMMATDMTGVVGTAI |
| | | | | ALKLLFGLPLMWGMLLTIADVLVVLLFLR |
| | | | | FGIRRVELIVLVSILTVGIIFGIEVARADP |
| | | | | SIGGIAGGFVPHTDILTNHGMLLLSLGI |
| | | | | MGATIMPHNIYLHSSLAQSRKYDEHIPA |
| | | | | QVTEALRFGKWDSNVHLVAAFLINALLL |
| | | | | ILGAALFYGVGGHVTAFQGVYNGLKNP |
| | | | | MIVGGLASPLMSTLFAFALLITGLISSIAS |
| | | | | TLAGQIVMEGYLNIRMPLWERRLLTRLV |
| | | | | TLIPIMVIGFMIGFSEHNFEQVIVYAQVS |
| | | | | LSIALPFTLFPLVALTNRRDLMGIHVNSQ |
| | | | | LVRWVGYFLTGVITVLNIQLAISVFV |
| Lactobacillus | 13 | WP_0057128 | 85.6 | MTKRNEQLSVQQAKPSLDEINRSVQVP |
| rhamnosus | | 42.1 | | GVYEPSFVQKFLAYSGPGALVAVGYMDP |
| | | | | GNWLTALEGGSRYHETLLAVLLLSILAA |
| | | | | MFMQTLAIKLGVVARLDLAQAIAAFVPK |
| | | | | WSRIGLWLVNEAAMMATDMTGVVGTA |
| | | | | IALKLLFGLPLMWGMLLTIADVLVVLMFL |
| | | | | RFGIRRIELIVLASILTVGIIFGIEVVRARP |
| | | | | SMGGIVAGLVPHTEILTNRGMLLLSLGI |
| | | | | MGATIMPHNIYLHSSLAQSRRYDEHIPA |
| | | | | QVTEALRFGKWDSNVHLVAAFIINALLLI |
| | | | | LGATLFYGMSSHATAFEGVYNGLKNPAI |
| | | | | VGGLASPLMSTLFAFALLITGLISSIASTL |
| | | | | AGQIVMEGYLNIQIPLWARRLLTRLVTLI |
| | | | | PIMIIGFVMGFSEQHFEQVIVYAQVALSI |
| | | | | ALPFTLFPLVALTDRRDLMGQHVNSPVV |
| | | | | RWMGYVLTGIITLLNVQLILSVILP |
| Lactobacillus | 14 | WP_0547687 | 72.4 | MSQEPTHKSLDEINQSVEVPSVYETSFL |
| kefiri | | 93.1 | | QKFLAYSGPGALVAVGYMDPGNWLTSL |
| | | | | SGGSQFRYALLSVLLMSILVAMFMQTLS |
| | | | | IKLGVVARLDLAQAIAQKVPKSGRYTLW |
| | | | | IINELAMMATDMTGVVGTAIALKLLFGLP |
| | | | | LVYGILLTIFDVLLVLLFLRFGIRRIEFIVL |
| | | | | AAILIVGVIFGIEVTRATPNIVEIAGGLIP |
| | | | | TTHIVTNHEMLIMSLGIVGATIMPHNVY |
| | | | | LHSSLAQSRRYDYHNPKQVNEALRFAK |
| | | | | WDSNVHLVAAFLINALLLVLGGTLFFHT |
| | | | | NSHFSAFQDVYNGLKSSAIVGSLASPLM |
| | | | | STLFAFALLITGMISSITSTLSGQIVMEG |
| | | | | YLHIRLPLWERRLLTRFVTLIPILAIGFLV |
| | | | | GFNDHDFEEIIVYAQIALSIALPFTLFPMV |
| | | | | ALTSNHDLMGVHTNRRYVTVIGYLLTSII |
| | | | | TILNLQFVLASI |
| Lactobacillus | 15 | WP_0577389 | 68.7 | MPNKKSLDEINESVKVPSVYDTSFLQKF |
| alimentarius | | 92.1 | | LAYSGPGALVAVGYMDPGNWLTSLSGG |
| | | | | SQYRYDLLSVLLISILVAMFMQTLSIKLG |
| | | | | VVARLDLAQAIATKVSKPIRYFLWILNEI |
| | | | | AMMATDLTGVIGTAIALKLLFNLPLVFGI |
| | | | | LLTVFDVLIVLIFLRFGIRRIEFIVLAAILT |
| | | | | VGIIFGIEVFRAQPKLFSIISGVIPSTDLF |
| | | | | TNHRKLVLSLGIVGATIMPHNIYLHSSLA |
| | | | | QSRRYDHNDPLQVNEALRFAKWDSNV |
| | | | | HLIAAFIINALLLVLGGTLFYHMTNQLAS |
| | | | | LQDVFTGLKSHAIVGTLASPLMSWLFAF |
| | | | | ALLITGMISSITSTLSGQIVMEGYLNIRL |
| | | | | PLWQRRLLTRFVTLIPILIIGFIVHFNEQD |
| | | | | FENLIVYAQIILSIALPFTLFPMIFLTNDKK |
| | | | | IMGNHVNSKLTTTVGIILASAITILNLQLL |
| | | | | FSLI |
| Lactobacillus | 16 | YP_00488917 | 67.4 | MQSHRHQSLEEINQSVAVPDVHQTAF |
| plantarum | | 7.1 | | WRKFLAYSGPGALVAVGYMDPGNWLT |
| | | | | SLAGGGQFQYRLLAVLALAIIVAMFMQG |
| | | | | LAIRLGVVARQDLAQAIASKLPRPVRYA |
| | | | | AWILNEVAMMATDMTGVIGTAIALKMLF |
| | | | | GLPLLAGILLTIADVLVVLLFLRFGIRRVE |
| | | | | VIVLVAILTVGIIFGIEVGRAHVQFGNVL |
| | | | | LGLVPTPLIVKNHTALVLSLGILGATIMP |
| | | | | HNLYLHSSLAQSRRYDYHNPAQVTEALR |
| | | | | FANWDSTVHLIAAFLINALLLVLGGTLFF |
| | | | | GHTNALASLQAVFDGLKSTTVVGALASP |
| | | | | VMSWLFALALLITGLISSITSTLAGQIVM |
| | | | | EGYLHIRLPLWQRRLLTRAVTLIPILIIGM |
| | | | | LVGFSDAAFENLIIYAQVALSIALPFTLLP |
| | | | | LVALTNDASLMKAHVNRPAVTWVGYGL |
| | | | | AGIITVLNIYLVYSLF |
| Lactobacillus | 17 | WP_0036689 | 65.8 | MERKSLDEINGSVDVPNVYQSAFWQKF |
| reuteri | | 01.1 | | LAYSGPGALVAVGYMDPGNWLTSLAGG |
| | | | | SQYRYQLLVVLFTAILIAMYMQSLAIKLG |
| | | | | VTTRTDLAQAIARRLPTPLRIALWLFNEI |
| | | | | AMMATDLTGVVGTAVALNMLFKLPLLIG |
| | | | | VLLTIADVLVVLFFLHFGIRRIEFIVLTAIL |
| | | | | VVGAIFAIEVCRAHPEFSAIMDGFVPRS |
| | | | | TIFTNHSELLISLGIVGATIMPHNIYLHSS |
| | | | | LAQSRRYDEHDPKQVKETLRFANWDSL |
| | | | | IHLFAAFIVNALLLILGGTLFFHAASLGSL |
| | | | | EDVFFGLKNPQIVGSLASPLMSWLFAFA |
| | | | | LLVTGLISSITSTLAGQIVMEGFINIRLPL |
| | | | | WKRRLLTRAVTLVPILIIGFMINFKEEQF |
| | | | | EQLIIYAQIVLSIALPFTLYPLVALTGNKK |
| | | | | LMGPHVNSRWQTVLGYILASLVTGLNLL |
| | | | | VLV |
| Lactobacillus | 18 | WP_0758872 | 61.4 | MTEKKSLDEINGSVAVPQYNTSFFRKFL |
| crustorum | | 52.1 | | AYSGPGALIAVGYMDPGNWLTSLVGGA |
| | | | | HHKYQLLSVLLISILVATFMQSLSIRLGI |
| | | | | ASRQDLAQAIAKKAKKPVRYCLWIINEL |
| | | | | AMMATDLTGVIGTALALNMLFKLPLVFG |
| | | | | VLITILDVFLILWFMRFGIRRIESIVVISIL |
| | | | | TVGLIFAFEVSHVQPNLTAIFKGFVPSQT |
| | | | | IITNQNKLILSLGIIGATIMPHNIYLHSAL |
| | | | | AQSRRYDYHDSRQVREALRFANWDSIV |
| | | | | HLIAALIINCLLLILGGTIFYDKADQLASL |
| | | | | MTVFKGLMNYQVVGSLASSFMSYLFAF |
| | | | | ALLVTGLISSITSTLSGQIVMEGYLNIRLP |
| | | | | LWQRRLLTRIITLIPILVIGFLVHFNEVIFE |
| | | | | DLIVYAQIALSVALPFTLFPLVYLTNNAKI |
| | | | | MGKHVNKKWQTILGFVLALIITILNIVLI |
| | | | | ATTLSH |

In a preferred embodiment, the lactic acid bacteria strain comprises a polypeptide having the sequence of SEQ ID NO: 3 (MSDDHKKRHPIKLIQYANGPSLEEINGTVEVPHGKGFWRTLFAYSGPGALVAVGYMDPGNWST SITGGQNFQYLLISVILMSSLIAMLLQYMAAKLGIVSQMDLAQAIRARTSKKLGIVLWILTELAIMA TDIAEVIGAAIALYLLFHIPLVIAVLVTVLDVLVLLLLTKIGFRKIEAIVVALILVILLVFVYQVALSDPN MGALLKGFIPTGETFASSPSINGMSPIQGALGIIGATVMPHNLYLHSAISQTRKIDYKNPDDVAQA VKFSAWDSNIQLSFAFVVNCLLLVMGVAVFKSGAVKDPSFFGLFQALSDSSTLSNGVLIAVAKSG ILSILFAVALLASGQNSTITGTLTGQVIMEGFVHMKMPLWARRLVTRIISVIPVIVCVMLTARDTPI QQHEALNTLMNNSQVFLAFALPFSMLPLLMFTNSKVEMGDRFKNTGWVKVLGWISVLGLTGLNL KGLPDSIAGFFGDHPTATQTNMANIIAIVLIVAILALLAWTIWDLYKGNQRYEAHLAAVADEKEAK ADVDEQ) or functional variants thereof.

In other preferred embodiments, the lactic acid bacteria strain is a bacteria strain comprising a polypeptide having at least 55%, such as at least 60%, 65%, 70%, 75%, 80%, 85%, 90%, 95%, 96%, 97%, 98%, 99% or 100% sequence identity with the sequence of SEQ ID NO: 3.

Table 3 shows exemplary sequences which encode functional variants of SEQ ID NO: 3 and their sequence identity with SEQ ID NO: 3.

TABLE 3

| | SEQ | | | |
|---|---|---|---|---|
| | ID | Protein | % | |
| Origin | NO | ID | identity | Sequence |
| Lactobacillus | 19 | WP_003567 | 99.8 | MSDDHKKRHPIKLIQYANGPSLEEINGTV |
| casei | | 390.1 | | EVPHGKGFWRTLFAYSGPGALVAVGYMD |
| | | | | PGNWSTSITGGQNFQYLLISVILMSSLIA |
| | | | | MLLQYMAAKLGIVSQMDLAQAIRARTSK |
| | | | | KLGIVLWILTELAIMATDIAEVIGAAIALYL |
| | | | | LFHIPLVIAVLVTVLDVLVLLLLTKIGFRKIE |
| | | | | AIVVALILVILLVFVYQVALSDPNMGALLK |
| | | | | GFIPTGETFASSPSINGMSPIQGALGIIGA |
| | | | | TVMPHNLYLHSAISQTRKIDHKNPDDVA |
| | | | | QAVKFSAWDSNIQLSFAFVVNCLLLVMG |
| | | | | VAVFKSGAVKDPSFFGLFQALSDSSTLSN |
| | | | | GVLIAVAKSGILSILFAVALLASGQNSTIT |
| | | | | GTLTGQVIMEGFVHMKMPLWARRLVTRII |
| | | | | SVIPVIVCVMLTARDTPIQQHEALNTLMN |
| | | | | NSQVFLAFALPFSMLPLLMFTNSKVEMGD |
| | | | | RFKNTGWVKVLGWISVLGLTGLNLKGLP |
| | | | | DSIAGFFGDHPTATQTNMANIIAIVLIVAI |
| | | | | LALLAWTIWDLYKGNQRYEAHLAAVADE |
| | | | | KEAKADVDEQ |
| Lactobacillus | 20 | WP_005686 | 95 | MSDDHKKKHSMKLIQYANGPSLEEINGT |
| rhamnosus | | 822.1 | | VEVPHGKGFWRTLFAYSGPGALVAVGYM |
| | | | | DPGNWSTSITGGQNFQYLLISVILMSSLI |
| | | | | AMLLQYMAAKLGIVSQMDLAQAIRARTS |
| | | | | KKLGIVLWILTELAIMATDIAEVIGAAIALY |
| | | | | LLFHIPLVIAVLVTVLDVLVLLLLTKIGFRKI |
| | | | | EAIVVALILVILLVFVYQVALSDPNMGALL |
| | | | | KGFIPTGETFASSPSVNGMSPIQGALGIIG |
| | | | | ATVMPHNLYLHSAISQTRKIDHKDPEDVA |
| | | | | QAVKFSAWDSNIQLTFAFVVNCLLLVMG |
| | | | | VAVFKSGAVKDPSFFGLFQALSDSSTLSN |
| | | | | GVLIAVAKSGILSILFAVALLASGQNSTIT |
| | | | | GTLTGQVIMEGFIHMKMPLWARRLVTRVI |
| | | | | SVIPVIVCVMLTARETPIQQHEALNTLMN |
| | | | | NSQVFLAFALPFSMLPLLMFTNSKVEMGD |
| | | | | RFKNTGWVKVLGWVSVIGLTYLNLKGLP |
| | | | | DSIAGFFGDNPTAAQTNIANMIAYVLIAA |
| | | | | VLALLAWTIWDLYKGNKRYEAHLEAVADE |
| | | | | EEAKANDDVQ |
| Lactobacillus | 21 | YP_0048905 | 76.3 | MSEKTNTPNRKHKLIEYANGPSLEEINGTI |
| plantarum | | 66.1 | | EVPKNLNFWKTLFAYSGPGALVAVGYMD |
| | | | | PGNWSTSITGGQNYQYMLMSVILISSLIA |
| | | | | MLLQYMAAKLGIVSQMDLAQAIRARTSK |
| | | | | SLGIVLWILTELAIMATDIAEVIGAAIALYL |
| | | | | LFNIPLVIAVFITVLDVLVLLLLTKIGFRKIE |
| | | | | AIVVCLILVILFVFVYQVALSNPDWGGVIK |
| | | | | GLVPTADTFSTSRSVNGMTPLSGALGIIG |
| | | | | ATVMPHNLYLHSAISQTRKIDHNDEEDVA |
| | | | | RTVKFAAWDSNIQLSFAFVVNSLLLIMGV |
| | | | | AVFKSGAVKDPSFFGLYEALSNTSMLSNG |
| | | | | ILISVAKSGALSALFAIALLASGQNSTITG |
| | | | | TLTGQVIMEGFVHMRMPLWLRRLVTRLIS |
| | | | | VIPVLICVLLTSGKSAIDEHTALNNLMNNS |
| | | | | QVFLAFALPFSMLPLLMMTDSAAEMGKRF |
| | | | | KNSLWIKGLGWLSVIGLTFLNLLGLPDSIL |
| | | | | GFFGDNPSAGEQTFSKILAYLLIAAILALLV |
| | | | | WTVFDLQRGNKRYVEQQLAAAAKEANK |
| Pediococcus | 22 | WP_065124 | 76.2 | MSNEIKNPKKRRKLISYANGRSLEEINGT |
| acidilactici | | 048.1 | | VKVPKNIGFWKTLFMYSGPGALVAVGYM |
| | | | | DPGNWSTSITGGQNFQYMLMSIILISSLI |
| | | | | AMLLQYMAAKLGIVSQMDLAQAIRARTS |
| | | | | RALGIVLWILTELAIMATDIAEVIGAAIALY |
| | | | | LLFHIPLVVAVFITVFDVLLLLLLTKIGFRKI |
| | | | | EAIVVCLIMVILVVFVYQVALSHPSWGAV |
| | | | | FGGLIPTTKAFATTPTVGGMTPLSGSLGII |
| | | | | GATVMPHNLYLHSAVSQTRKINHDDEED |
| | | | | VARTVRFSTWDSNIQLSFAFVVNALLLVM |
| | | | | GVAVFKTGAVQDPSFFGLFHALNDTSTLS |
| | | | | NGILIGVAKTGILSTLFAVALLASGQNSTI |
| | | | | TGTLTGQVIMEGFVHMRMPLWARRLITRL |
| | | | | ISVVPVLICVMLTSGKGTIQEHEALNNLM |
| | | | | NNSQVFLAFALPFSMVPLLMMTDSRVEM |
| | | | | GDRFKNSWIVRILGWISVIFLTYLNLTGLP |
| | | | | DSIAAFFGENASAAEISMAHDIAYALIVAV |
| | | | | LALLAWTVIELYKGNKRYEIELAEKANAKE |
| | | | | AA |
| Lactobacillus | 23 | YP_535797. | 72.7 | MVNNENNHKKHKMIQYANGKSLEEANG |
| salivarius | | 1 | | TVEIPKGKGFWKTLFAYSGPGALVAVGYM |
| | | | | DPGNWSTSITGGQNFQYLLMSVILLSSLI |
| | | | | AMLLQYMAAKLGIVSQMDLAQAIRARTS |
| | | | | KALGIVLWILTELAIMATDIAEVIGAAIALY |
| | | | | LLFDIPLIIAVFITVFDVLLLLLLTKVGFRKI |
| | | | | EAIVVCLIFVILFVFVYQVALSNPDWGGVF |
| | | | | KGLIPTSETFAKHPVVHDMSPLNGALGII |
| | | | | GATVMPHNLYLHSAISQTRKFDRNNEDDI |
| | | | | ANAVRFTAWDSNIQLGLAFVVNSLLLIMG |
| | | | | VAVFKSGAVEDPSFFGLYQALSDTSVMS |
| | | | | NGLLAAAARTGILSTLFAVALLASGQNSTI |
| | | | | TGTLTGQVIMEGFIHLRMPLWARRLITRLL |
| | | | | SVIPVLICVALTSGKSTIEEHEALNNLMNN |
| | | | | SQVFLAFALPFSMLPLVIMTGSKVEMGER |
| | | | | FKNRLWINILGWISVISLTYLNMIGLPQNL |
| | | | | EPFFPADKVGLAHTVAYILIVLIIALLIWTL |
| | | | | VELHLGNKRFAAEQAKKHNK |
| Lactobacillus | 24 | WP_012391 | 69.6 | MDNTKNQHRKLRLIEHANGKSLEEINGTV |
| fermentum | | 805.1 | | EVPHGKGFFRTLFAYSGPGALVAVGYMDP |
| | | | | GNWSTSITGGQSFQYTLMTTILISSLIAML |
| | | | | LQYMAAKLGIVSQMDLAQAIRARTGKAL |
| | | | | GVILWLMTELAIMATDIAEVIGAAIALNLL |
| | | | | FHIPLVLAVFITVLDVLVLLLLTKIGFRKIEA |
| | | | | IVACLILVILAVFAYQVALSHPDWAGVFKG |
| | | | | LLPTKEAIAKEPVVGGISPLTGSLGIIGATV |
| | | | | MPHNLYLHSAISQTRKIDHTNAEDIKQTV |
| | | | | RFTAWDSNIQLTLAFFVNALLLIMGVAVF |
| | | | | KNGAVQDSSFFGLYDALNNTDMLSNGLL |
| | | | | IAVAKSGVLSTLFAIALLASGQNSTITGTL |
| | | | | TGQVIMEGFVHMKMPLWARRLITRLLSVV |
| | | | | PVLVCVAMTAHESTIDQHASLNILMENSQ |
| | | | | VFLAFALPFSMLPLLIMTNSDTEMGQFKN |
| | | | | SLWVRVLGWISVIGLTFLNLYNLPQTYEG |
| | | | | FGIWSKGLSDVLAWISIVVIVVLLAWTCF |
| | | | | ELIRGDRRLAAEREKHTWEK |
| Lactobacillus | 25 | WP_080881 | 63.7 | MCSRKVLLTKQKGKHYLIRYANGKSLSEI |
| amylolyticus | | 380.1 | | NGTIEIPKKRTFWRMLWAYTGPGALVAV |
| | | | | GYMDPGNWATSITGGQSFQYILMSTILIS |
| | | | | SLMAMLLQYMAAKLGIVTQMDLAQAIRLR |
| | | | | TGKALGIVLWLMTELAIMATDIAEVIGAAI |
| | | | | ALNLLFDIPLVPAVFITVLDVLLLLLLARIGF |
| | | | | RKIEAVVSCLILVILLVFVYEVLLSNPDWS |
| | | | | KAFVGLVPSAKIIQTHPVVGGISPLTGTLG |
| | | | | IIGATVMPHNLYLHSAISQTRKINHHNLQL |
| | | | | IRDAVKYTALDSNIQLSLAFLVNALLLIMG |
| | | | | AAVFKSGAVRDSSFFGLYQALDNAKMLS |
| | | | | DPLLVHVARTGILSTLFAVALLASGQNSTI |
| | | | | TGTLTGQVIMEGYIHLKMPLWARRLVTRL |
| | | | | LSVIPVLLCVSFTMNDSVMQQHFALNML |
| | | | | MENSQVFLAFALPFSVLPLLIMTNNKAEM |
| | | | | GEFKNKPLWHYLGWACALVLTFLNLYNLP |
| | | | | SQFVNFKFASKEVSTIIAYFVIVVIAALLL |
| | | | | WTCIEIYIGDRKVKIHHSGFDAKEKELKE |
| | | | | EGQK |

For purposes of the present invention, the degree of “sequence identity” between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the nobrief option) is used as the percent identity and is calculated as follows:

(Identical Residues×100)/(Length of Alignment−Total Number of Gaps in Alignment)

For purposes of the present invention, the degree of sequence identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 3.0.0 or later. The optional parameters used are gap open penalty of 10, gap extension penalty of 0.5, and the EDNAFULL (EMBOSS version of NCBI NUC4.4) substitution matrix. The output of Needle labeled “longest identity” (obtained using the nobrief option) is used as the percent identity and is calculated as follows:

(Identical Deoxyribonucleotides×100)/(Length of Alignment−Total Number of Gaps in Alignment).

In an embodiment, the lactic acid bacteria strain comprises a manganese transporter having at least 55%, such as at least 60%, 65%, 70%, 75%, 80%, 85%, 90%, 95%, 96%, 97%, 98%, 99% or 100% sequence identity with the sequences of any one of SEQ ID NO: 1-3. The determination can be based on sequencing the bacteria strain or a blast search in known sequence databases.

The lactic acid bacteria used in the Examples sections in the present disclosure have manganese transporter as encoded SEQ ID NO: 1-3 or functional variants thereof. In a preferred embodiment, the lactic acid bacterium may be selected from a group consisting of Lactobacillus plantarum, Lactobacillus fermentum, Lactobacillus reuteri, Lactobacillus sakei, Lactobacillus brevis, Lactobacillus casei, Lactobacillus paracasei, Lactobacillus salivarius, Lactobacillus alimentarius, Pediococcus acidilactici, Lactobacillus rhamnosus and Lactobacillus kefiri.

Direct Vat Sets (DVS)

In one embodiment, the present invention provides a frozen-direct vat set (F-DVS) starter culture composition comprising lactic acid bacteria for fermenting a food product and for inhibiting or delaying growth of fungi in said food product, characterized in that the composition comprises up to 600 ppm of manganese and the concentration of the lactic acid bacteria is of at least 1E+10 colony forming unit/g.

In another embodiment, the present invention provides a freeze-dried vat set (FD-DVS) starter culture composition comprising lactic acid bacteria for fermenting a food product and for inhibiting or delaying growth of fungi in said food product, characterized in that the composition comprises up to 600 ppm of manganese and the concentration of the lactic acid bacteria is of at least 1E+10 colony forming unit/g.

In some embodiments, the lactic acid bacteria are Lactobacillus plantarum, Lactobacillus fermentum, Lactobacillus reuteri, Lactobacillus sakei, Lactobacillus brevis, Lactobacillus casei, Lactobacillus paracasei, Lactobacillus salivarius, Lactobacillus alimentarius, Pediococcus acidilactici, Lactobacillus rhamnosus and Lactobacillus kefiri. Preferably, the lactic acid bacteria are Lactobacillus paracasei or Lactobacillus rhamnosus.

Preparation of preparing freeze dried or frozen bacteria culture is known in the art, for example as disclosed in U.S. Pat. No. 9,848,615.

Commercial relevant highly concentrated frozen culture generally has a concentration of bacteria of at least 1E+9 CFU per g. In preferred embodiment, the bacteria in the composition according to the present invention has a concentration of at least 1E+10 CFU per g, including 2E+10, 3E+10, 4E+10, 5E+10, 6E+10, 7E+10, 8E+10, 9E+10 CFU per g. In other embodiments, the bacteria in the composition has a concentration of at least 1E+11 CFU per g, including 2E+10, 3E+10, 4E+10, 5E+10, 6E+10, 7E+10, 8E+10, 9E+10 CFU per g. To obtain this longer fermentation time may be needed.

Products

In some embodiments, the product is a food product, cosmetic product, health care product or a pharmaceutical product. “Food” and “food product” have the common meaning of these terms. “Food product” refers to any food or feed products suitable for consumption by humans or animals. Food products can be fresh or perishable food products as well as stored or processed food products. Food products include, but are not limited to, fruits and vegetables including derived products, grain and grain-derived products, dairy products, meat, poultry and seafood. More preferably, the food product is a meat product or dairy product, such as yoghurt, tvarog, sour cream, cheese and the like. The food product may also be plant-based products or ready-to-eat products such as salad.

In one embodiment, the composition described herein can be added to non-fermented food products or fermented food products. Non-fermented products have generally a higher pH than fermented food products. Fermented food products are foods produced or preserved by the action of microorganisms. Fermentation means the conversion of carbohydrates into alcohols or acids through the action of a microorganism. Fermentation typically refers to the fermentation of sugar to alcohol using yeast. However, it may also involve the conversion of lactose to lactic acid. For example, fermentation may be used to make foods such as yogurt, cheese, salami, sauerkraut, kimchi, pickle and the like.

The present invention is particularly useful in inhibiting or delaying growth of fungi in dairy products. In such products, contamination with yeast and molds are common and limits the shelf life of such products. “Dairy product” includes, in addition to milk, products derived from milk, such as cream, ice cream, butter, cheese and yoghurt, as well as secondary products such as lactoserum and casein and any prepared food containing milk or milk constituents as the main ingredient, such as formula milk. In one preferred embodiment, the dairy product is a fermented dairy product. The term “milk” is understood as the lacteal secretion obtained by milking any mammal, such as cows, sheep, goats, buffaloes or camels. In a preferred embodiment, the milk is cow's milk. The term milk also includes protein/fat solutions made of plant materials, e.g. soy milk.

In one embodiment, the food product is a product prepared by fermentation with thermophiles, i.e. thermophilic fermented food product. The term “thermophile” refers to microorganisms that thrive best at temperatures above 43° C. The industrially most useful thermophilic bacteria include Streptococcus spp. and Lactobacillus spp. The term “thermophilic fermentation” herein refers to fermentation at a temperature above about 35° C., such as between about 35° C. and about 45° C. “Thermophilic fermented food product” refers to fermented food products prepared by thermophilic fermentation of a thermophilic starter culture. Include in such products are for example yogurt, skyr, labneh, lassi, ayran and doogh.

In one embodiment, the food product is a product prepared by fermentation with mesophiles, i.e. mesophilic fermented food product. The term “mesophile” refers to microorganisms that thrive best at moderate temperatures (15° C.-40° C.). The industrially most useful mesophilic bacteria include Lactococcus spp. and Leuconostoc spp. The term “mesophilic fermentation” herein refers to fermentation at a temperature between about 22° C. and about 35° C. “Mesophilic fermented food product,” which refers to fermented food products prepared by mesophilic fermentation of a mesophilic starter culture. Included in such products are for example buttermilk, sour milk, cultured milk, smetana, sour cream and fresh cheese, such as quark, tvarog and cream cheese.

Preparation of Fermented Products

The composition herein is particularly useful to inhibit or delay yeast and/or mold growth in fermented milk product such as thermophilic and mesophilic fermented milk product, for example a yogurt product. The term “fermented milk product” is a term generally defined in accordance with relevant official regulations and the standards are well known in the field. For example, symbiotic cultures of Streptococcus thermophilus and Lactobacillus delbrueckii subsp. bulgaricus are used as starter culture for yogurt, whereas Lactobacillus acidophilus is used to make acidophilus milk. Other mesophilic lactic acid bacteria are used to produce quark or fromage frais.

The expression “fermented milk product” means a food or feed product wherein the preparation of the food or feed product involves fermentation of a milk base with a lactic acid bacterium. “Fermented milk product” as used herein includes but is not limited to products such as thermophilic fermented milk products (e.g. yogurt) and mesophilic fermented milk products (e.g. sour cream and buttermilk, as well as fermented whey, quark and fromage frais). Fermented milk product also includes cheese, such as continental type cheese, fresh cheese, soft cheese, cheddar, mascarpone, pasta filata, mozzarella, provolone, white brine cheese, pizza cheese, feta, brie, camembert, cottage cheese, Edam, Gouda, Tilsiter, Havarti or Emmental, Swiss cheese, and Maasdamer.

The term “yogurt” has its usual meaning and is generally defined in accordance with relevant official regulations and standards are well known in the field. Starter cultures used for making yogurt comprises at least one Lactobacillus delbrueckii subsp. bulgaricus strain and at least one Streptococcus thermophilus strain. Interestingly, the manganese transporter is not present in L. delbrueckii subsp. bulgaricus and only displays low expression in Streptococcus thermophilus, the two strains found in the starter culture in yoghurt, making them particularly susceptible to fungal spoilage. It is therefore preferable to include other bacteria strain(s) to scavenging free manganese present in yogurt.

During food processing chemical preservatives have traditionally been used to avoid fungal spoilage. However, in view of a strong societal demand for less processed and preservative-free foods, the invention contributes to provide an effective solution to manage yeast and mold growth by using a composition for fermenting a food product and for inhibiting or delaying growth of fungi in said food product comprising up to 600 ppm of manganese and a lactic acid bacterium with a colony forming unit/g of cells of at least 2E+10.

When the composition now disclosed, the skilled person is able to adjust various parameters such as pH, temperature, and amount of said composition to achieve the desired results, taking into consideration the examples provided in this disclosure as well as the properties of the food product such as water activity, nutrients, level of naturally occurring manganese, shelf life, storage conditions, packing, etc.

The composition now disclosed may be added before, at the start, or during the fermentation of a given product and said product may be further packaged to further limit contact with yeast and mold and/or it may also be stored under cold temperature (below 15° C.) to help extend shelf life.

The composition now disclosed may be added before, at the start, or during the fermentation of a given fermented dairy product. To make fermented dairy products, the food substrate is a milk base. “Milk base” is broadly used in the present application to refer to a composition based on milk or milk components which can be used as a medium for growth and fermentation of a starter culture. “Milk” generally refers to the lacteal secretion obtained by milking of any mammal, such as cows, sheep, goats, buffaloes or camels. Milk base can be obtained from any raw and/or processed milk material as well as from reconstituted milk powder. Milk base can also be plant-based, i.e. prepared from plant material e.g. soy milk. Milk base prepared from milk or milk components from cows is preferred.

Milk bases include, but are not limited to, solutions/suspensions of any milk or milk like products comprising protein, such as whole or low-fat milk, skim milk, buttermilk, reconstituted milk powder, condensed milk, dried milk.

Milk base may also be lactose-reduced depending on the need of the consumers. Lactose-reduced milk can be produced according to any method known in the art, including hydrolyzing the lactose by lactase enzyme to glucose and galactose, or by nanofiltration, electrodialysis, ion exchange chromatography and centrifugation.

To ferment the milk base food-grade microorganisms are added.

After adding the starter culture, the composition now disclosed and subjecting the milk base to a suitable condition, the fermentation process begins and continues for a period of time. A person of ordinary skill in the art knows how to select suitable process conditions, such as temperature, oxygen, addition of carbohydrates, amount and characteristics of microorganism(s) and the process time it takes. This process may take from three, four, five, six hours or longer.

These conditions include the setting of a temperature which is suitable for the particular starter culture strains. For example, when the starter culture comprises mesophilic lactic bacteria, the temperature can be set to about 30° C., and if the culture comprises thermophilic lactic acid bacterial strains, the temperature is kept in the range of about 35° C. to 50° C., such as 40° C. to 45° C. The setting of the fermentation temperature also depends on the enzyme(s) added to the fermentation which can be readily determined by a person of ordinary skill in the art. In a particular embodiment of the invention the fermentation temperature is between 35° C. and 45° C., preferably between 37° C. and 43° C., and more preferably between 40° C. and 43° C. In another embodiment, the fermentation temperature is between 15° C. and 35° C., preferably between 20° C. and 35° C., and more preferably between 30° C. and 35° C.

Fermentation can be terminated using any methods known to in the art. In general, depending on various parameters of the process, the fermentation can be terminated by making the milk base unsuitable for the strain(s) of the starter culture to grow. For example, termination can be carried out by rapid cooling of the fermented milk product when a target pH is reached. It is known that during fermentation acidification occurs, which leads to the formation of a three-dimensional network consisting of clusters and chains of caseins. The term “target pH” means the pH at which the fermentation step ends. The target pH depends on the fermented milk product to be obtained and can be readily determined by a person of ordinary skill in the art.

In particular embodiments of the invention, fermentation is carried out until at least a pH of 5.2 is reached, such as until a pH of 5.1, 5.0, 4.9, 4.8, 4.7, 4.6, 4.5, 4.4, 4.3, 4.2, 4.1, 4.0, 3.9, 3.8 or 3.7 is reached. Preferably, the fermentation is carried out until a target pH between 4.0 and 5.0 and more preferably between 4.0 and 4.6 is reached. In a preferred embodiment, the fermentation is carried out until target pH below 4.6 is reached.

In a preferred embodiment, fermented food product is selected from the group consisting of quark, cream cheese, fromage frais, greek yogurt, skyr, labneh, butter milk, sour cream, sour milk, cultured milk, kefir, lassi, ayran, twarog, doogh, smetana, yakult and dahi.

In another preferred embodiment, fermented food product is a cheese, including continental type cheese, fresh cheese, soft cheese, cheddar, mascarpone, pasta filata, mozzarella, provolone, white brine cheese, pizza cheese, feta, brie, camembert, cottage cheese, Edam, Gouda, Tilsiter, Havarti or Emmental, Swiss cheese, and Maasdamer.

Other features and advantages of the invention will become apparent from reading the following description in conjunction with the accompanying figures. Unless otherwise defined, all terms used herein have the same meaning as commonly understood by one of ordinary skill in the art. The use of the terms “a” and “an” and “the” and similar referents in the context of describing the invention (especially in the context of the following claims) are to be construed to cover both the singular and the plural, unless otherwise indicated herein or clearly contradicted by context. The terms “comprising”, “having”, “including” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. Unless otherwise stated, all exact values provided herein are representative of corresponding approximate values (e.g. all exact exemplary values provided with respect to a particular factor or measurement can be considered to also provide a corresponding approximate measurement, modified by “about”, where appropriate). The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

### EXAMPLES

The invention described and claimed herein is not to be limited in scope by the specific aspects herein disclosed, since these aspects are intended as illustrations of several aspects of the invention. Any equivalent aspects are intended to be within the scope of this invention. Indeed, various modifications of the invention in addition to those shown and described herein will become apparent to those skilled in the art from the foregoing description and the following examples. Such modifications are also intended to fall within the scope of the appended claims. In the case of conflict, the present disclosure including definitions will prevail.

Quantification of Manganese

For each composition herein disclosed the manganese concentration was determined using inductively coupled plasma mass spectrometry (ICP-MS), in particular after performing a microwave assisted digestion. Cell cultures were collected after growth and submitted to standard procedures to obtain either a F-DVS form or a FD-DVS form. Furthermore, also the CFU/g was determined. The skilled person in the art knows how to perform inductively coupled plasma mass spectrometry and how to determine CFU/g.

The results obtained are depicted in table 4.

TABLE 4

| | | Mn concentration | |
|---|---|---|---|
| Strains | Form | (mg/kg ≈ mg/L = ppm) | CFU/g |
| L. rhamnosus | F-DVS | 30 | 6.0E+10 |
| strain 1 | | 195 | 2.6E+11 |
| | | 625 | 1.8E+11 |
| L. rhamnosus | F-DVS | 45 | 2.8E+11 |
| strain 2 | | 930 | 3.2E+11 |
| | FD-DVS | 200 | 5.6E+11 |
| L. rhamnosus | F-DVS | 65 | 1.4E+11 |
| strain 1 and | | | |
| L. rhamnosus | | | |
| strain 2 | | | |
| L. rhamnosus | FD-DVS | 275 | 6.4E+11 |
| strain 3 and | | | |
| L. paracasei | | | |
| Benchmark A | FD | 845 | 3.2E+11 |
| Benchmark B | FD | 630 | 2.4E+11 |
| Benchmark C | FD | 870 | 2.6E+11 |

Preparation of Fermented Milk Samples

The fermented milk samples used in the present disclosure were prepared as follows. Homogenized milk, in particular reduced-fat (1.5% w/v) homogenized milk, was heat-treated at 90±1° C. for 20 min and cooled immediately. Manganese concentration already present in the homogenized milk was previously determined to be about 0.03 ppm. A commercial starter culture (Streptococcus thermophilus and Lactobacillus delbrueckii subsp. bulgaricus) was inoculated at 0.02% (v/w) in 3 L buckets or 200 ml bottles. A first bucket was inoculated with a composition comprising, in total concentration of 1E+7 CFU/g of, L. rhamnosus strain (strain 1) and about 30 ppm of manganese; a second bucket was inoculated with a composition comprising, in total concentration of 1E+7 CFU/g of L. rhamnosus strain (strain 1) and about 195 ppm of manganese; a third bucket was inoculated with a composition comprising, in total concentration of 1E+7 CFU/g of, L. rhamnosus strain (strain 1) and about 625 ppm of manganese; a fourth bucket was inoculated with a composition comprising, in total concentration of 1E+7 CFU/g of, L. rhamnosus strain (strain 3) and L. paracasei strain and about 275 ppm of manganese; and a fourth bucket was used as a reference and only inoculated with the starter culture. All buckets were incubated in a water bath at 43±1° C. and fermented at these conditions until pH of 4.60±0.1 was reached. The fermented milk products were divided into 200 mL bottles and cooled down.

All parts of the fermented milk samples were warmed to a temperature of 40° C. and added 40 ml of a 5% sterile agar solution that had been melted and cooled down to 60° C. This solution of fermented milk and agar was then poured into sterile Petri dishes and the plates were dried in a LAF bench for 30 min. These plates were used challenge tests using molds and for challenge using yeasts where growth was evaluated by scoring.

Challenge Test Using Molds

In the present disclosure, the challenge tests using molds were carried out as follows. Different target contaminants (P. crustosum, P. roqueforti and P. paneum or P. carneum), were added in concentrations of 500 spores each/spot. Plates were incubated at selected temperatures and times, and regularly examined for the growth of mold.

Challenge Test Using Yeasts

In the present disclosure, the challenge tests using yeasts were carried out as follows. Growth or growth score of different target contaminants (T. delbrueckii, D. hansenii, C. fragiola, Y. lipolytica) was tested by inoculating about 50 CFU/g of each target contaminant in a fermented milk sample, such as yogurt.

### Example 1 Inhibition of Molds in Fermented Milk Products with Compositions Comprising Lactic Acid Bacteria and Different Manganese Concentrations

The example demonstrates the influence of manganese on the inhibitory effect against different molds. An agar-assay resembling the manufacturing process and production of fermented milk products was used. Lactobacillus rhamnosus and Lactobacillus paracasei strains were used.

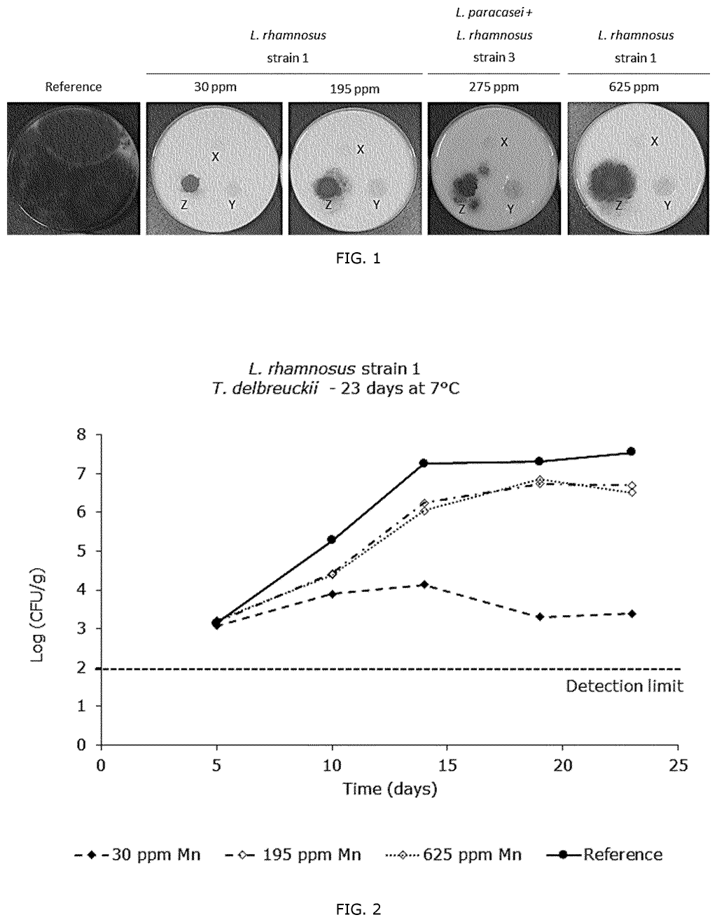

FIG. 1 shows the growth of 3 different molds (P. crustosum, P. carneum and P. roqueforti) on plates prepared from milk fermented with starter culture (reference) or additionally with a composition comprising lactic acid bacteria and different manganese concentrations, namely a composition comprising lactic acid bacteria and about 30 ppm of manganese, or about 195 ppm of manganese, or about 275 ppm of manganese, or about 625 ppm of manganese. Three target contaminants were added in concentrations of 500 spores/spot. The plates were incubated at 22±1° C. for 7 days.

FIG. 1 demonstrates that inhibition of tested molds is more pronounced when a composition comprising lactic acid bacteria and low concentrations of manganese, namely when about 30, about 195 ppm or about 275 ppm of manganese is used. A composition comprising lactic acid bacteria and about 625 ppm of manganese is still able to inhibit the growth of P. crustosum (X) and P. carneum (Y), but not of P. roqueforti (Z). Furthermore, when no such composition is used, tested molds proliferate, leading to the spoilage of the fermented milk product.

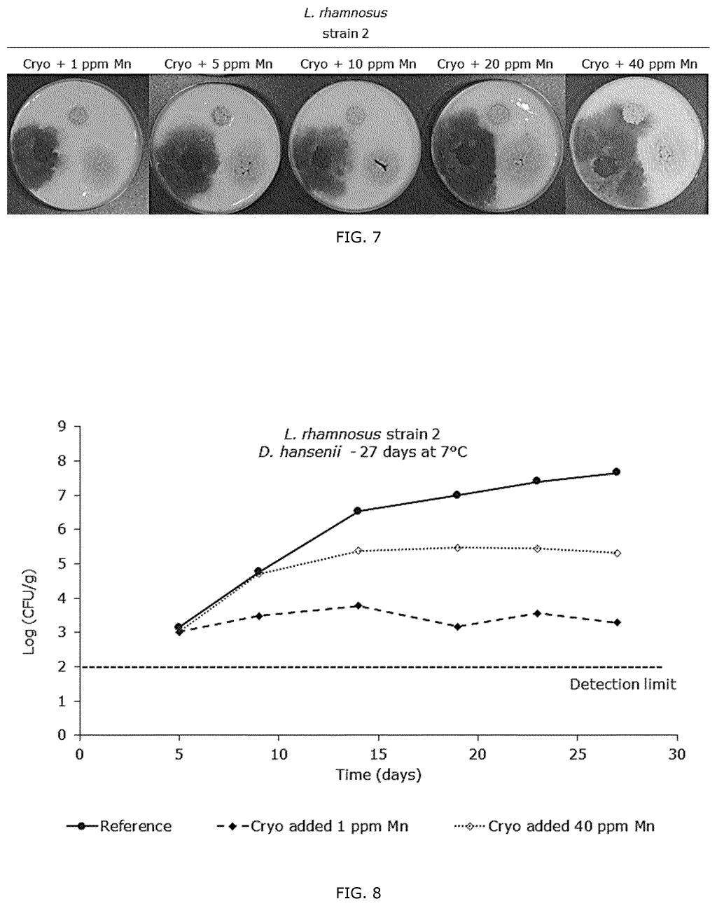

FIG. 7 shows the growth of 3 different molds on plates prepared from milk fermented with starter culture (reference) or additionally with a freeze-dried (FD-DVS) DVS composition comprising lactic acid bacteria, wherein the FD-DVS form has about 200 ppm of manganese and the cryoprotectant used was further supplemented with different concentrations of manganese (1, 5, 10, 20 and 40 ppm). The yogurt was spiked with P. crustosum, P. carneum and P. roqueforti (500 spores/each) and stored at 22° C. for 12 days.

FIG. 7 demonstrates a growth impairment of the tested molds when submitted to conditions where manganese is scarce versus a condition when manganese is abundant. Thus, when manganese is added to the cryoprotectant it promotes the growth of the tested molds leading to the spoilage of food. Therefore, FIG. 7 surprisingly shows the need of having a FD-DVS form of the composition now disclosed deprived of manganese, specially deprived of cryoprotectants having manganese in their composition, such as skimmed milk powder.

In conclusion, all tested molds grew very well on the agar plates made from milk fermented only with the starter culture (reference). Thus, when no composition comprising lactic acid bacteria and manganese is used, the tested molds can proliferate, leading to the spoilage of the fermented milk products. Furthermore, FIG. 1 demonstrate that the inhibition of the different tested molds is possible, when fermented milk products are submitted to a composition comprising lactic acid bacteria and different concentrations of manganese, the effect being more pronounced when lower concentrations of manganese was used. Thus, using a composition comprising a lactic acid bacteria and low levels of manganese, such as below 600 ppm of manganese, more preferably below 275 ppm, even more preferably below 200 pm such as about 30 to about 200 ppm or about 45 ppm to about 200 ppm, avoids the spoilage of fermented milk products.

### Example 2 Inhibition of Molds in Fermented Milk Products with Compositions Comprising Lactic Acid Bacteria and Different Manganese Concentrations Versus the Prior Art

A comparison between the composition of the present invention versus prior art was also carried out.

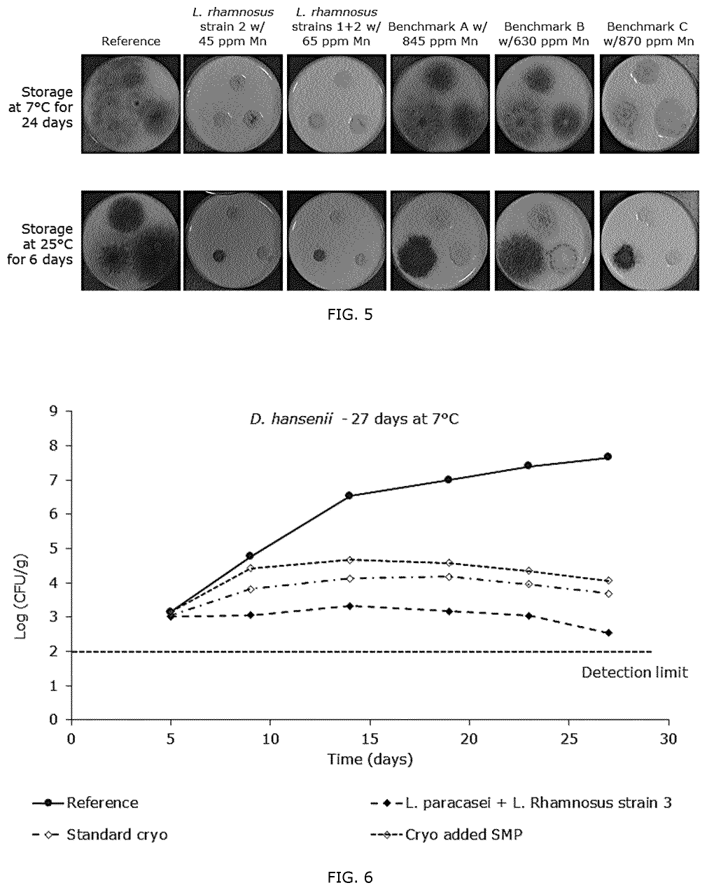

FIG. 5 shows the growth of 3 different molds (P. crustosum, P. paneum and P. roqueforti) on plates prepared from milk fermented with starter culture alone (reference) or additionally with a composition comprising lactic acid bacteria (strains 2 or 1+2) combined low levels of manganese, such as 45 or 65 ppm of manganese, or additionally with a benchmark composition (A, B or C). The benchmark composition A is Holdbac® XPM having 845 ppm of manganese; the benchmark composition B is Holdbac® YM-B Plus having 630 ppm of manganese; the benchmark composition C is Holdbac® YM-C having 870 ppm of manganese.

FIG. 5 demonstrates that a composition comprising lactic acid bacteria and a low concentration of manganese, such as a concentration below about 600 ppm of manganese, preferably a concentration of about 40-600 ppm of manganese or a concentration of about 45-600 ppm of manganese, more preferably a concentration of 40-70 ppm of manganese, is responsible for avoiding the spoilage of food independently of the conditions used for storage of the fermented milk samples, such as 7±1° C. for 24 days versus 25±1° C. for 11 days.

### Example 3 Inhibition of Yeasts in Fermented Milk Products with Compositions Comprising Lactic Acid Bacteria and Different Manganese Concentrations

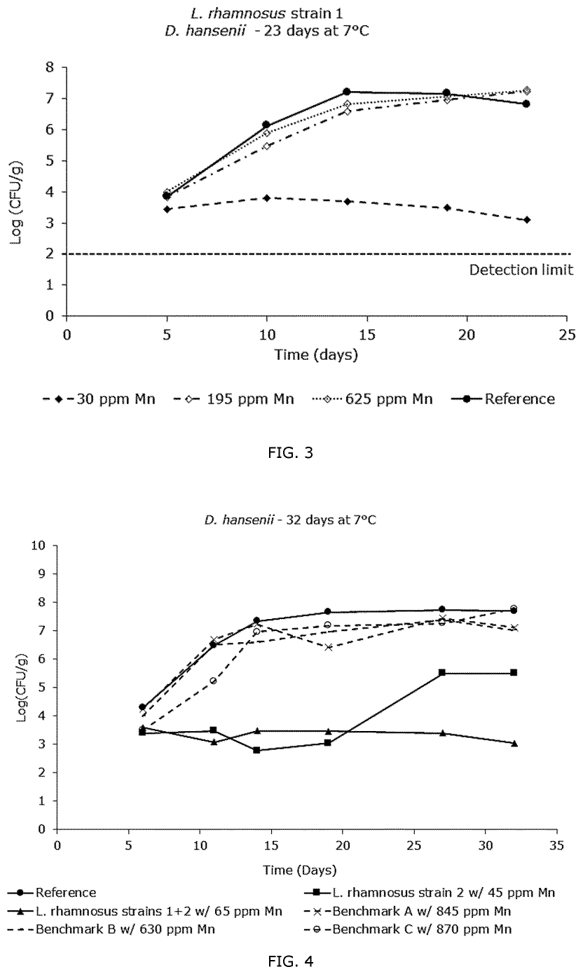

This example demonstrates the growth challenges that different yeasts, such as Torulaspora or Debaryomyces, face when inoculated in a fermented milk product fermented with starter culture alone (reference) or additionally with a composition comprising lactic acid bacteria (such as L. rhamnosus strain 1, L. rhamnosus strain 2, L. rhamnosus strain 3, L. paracasei) and about 30 ppm of manganese, or about 195 ppm of manganese, or about 275 ppm of manganese, or about 625 ppm of manganese. The growth challenge was kept at 7±1° C. for 23 days (FIGS. 2-3) or for 27 days (FIG. 6).

FIGS. 2 and 3 show a growth impairment of different yeasts (Torulaspora and Debaryomyces) when inoculated in a fermented milk product fermented with starter culture additionally with a composition comprising lactic acid bacteria and about 30 ppm of manganese, or about 195 ppm of manganese, or about 625 ppm of manganese. This impairment was more drastic and prolonged for a composition comprising about 30 ppm of manganese (FIGS. 2-3). However, still compositions having about 195 ppm of manganese, or about 625 ppm of manganese were responsible for the growth impairment of the tested yeasts but to a lesser extent, showing this way that compositions comprising lactic acid bacteria and lower concentrations of manganese do influence the growth of fungi and consequently the spoilage of food.

FIG. 6 additional shows that a composition comprising lactic acid bacteria and about 275 ppm of manganese is responsible for a significant reduction in the growth of yeast, such as Debaryomyces. The composition of the cryoprotectant used is: sodium caseinate, inositol monosodium glutamate, sodium ascorbate and water, preferably with the proviso that manganese is excluded. All values are given in % w (ingredient)/w (cryoprotectant solution). For example: sodium caseinate 5.55, inositol 3.75 monosodium glutamate 3.75, sodium ascorbate 5.65 and water 81.3, preferably wherein manganese is excluded. All values are given in % w (ingredient)/w (cryoprotectant solution).

FIG. 8 further shows the growth of Debaromyces on a milk fermented product that has been inoculated only with starter culture (reference) or additionally with a freeze-dried DVS composition comprising lactic acid bacteria (such as L. rhamnosus strain 2), wherein the FD-DVS form has about 200 ppm of manganese and was further supplemented with different concentrations of manganese (1 and 40 ppm). Therefore, FIG. 8 surprisingly shows the need of having a FD-DVS form of the composition deprived of manganese, specially deprived of cryoprotectants having manganese in their composition, such as skimmed milk powder.

### Example 4 Inhibition of Yeasts in Fermented Milk Products with Compositions Comprising Lactic Acid Bacteria and Different Manganese Concentrations Versus the Prior Art

A comparison between a composition herein disclosed versus prior art was also carried out.

FIG. 4 shows the growth of Debaryomyces in fermented milk product, when said product only has a starter culture alone (reference) or additionally with a composition comprising lactic acid bacteria (L. rhamnosus strains 2 or L. rhamnosus strains 1+2) combined low levels of manganese, such as about 45 or about 65 ppm of manganese, or additionally with a benchmark composition (A, B or C). The benchmark composition A is Holdbac® XPM having 843 ppm of manganese; the benchmark composition B is Holdbac® YM-B Plus having 630 ppm of manganese; the benchmark composition C is Holdbac® YM-C having 870 ppm of manganese.

FIG. 4 demonstrates a significant growth impairment of Debaryomyces on a fermented milk product when submitted to a composition comprising lactic acid bacteria and low concentrations of manganese (such as 45 ppm or 65 ppm) versus the benchmark compositions comprising more than 600 ppm of manganese.

1. A direct vat set starter culture composition comprising lactic acid bacteria comprising a manganese transporter for fermenting a food product and for inhibiting or delaying growth of fungi in said food product,
characterized in that
the composition comprises up to 600 ppm of manganese and
the concentration of the lactic acid bacteria is of at least 1E+10 colony forming unit/g,
wherein, optionally, the lactic acid bacteria are free of a superoxide dismutase, preferably free of a manganese superoxide dismutase.

2. The composition according to the preceding claim comprising up to 400 ppm of manganese, preferably up to 300 ppm of manganese, more preferably up to 250 ppm, even more preferably up to 200 ppm.

3. The composition according to any of the preceding claims comprising 30-600 ppm, preferably 35-600 ppm or 40-400 ppm or 40-300 ppm or 40-250 ppm, more preferably comprising 40-200 ppm or 45-200 ppm manganese.

4. The composition according to any of the preceding claims, wherein concentration of the lactic acid bacteria is of 2.0E+10-6.5E+11, preferably 6.0E+10-6.4E+11, more preferably 1.3E+11-5.6E+11, colony forming unit/g.

5. The composition according to any of the preceding claims, wherein the composition is a frozen-direct vat set (F-DVS) or a freeze-dried vat set (FD-DVS).

6. The composition according to any of the preceding claims, wherein the composition is a freeze-dried direct vat set (FD-DVS) composition comprising 2% to 70% of an additive, preferably 3% to 50% of additive, more preferably 4% to 40% of additive, even more preferably 10% to 30% of additive or 20 to 30% of additive, measured as dry weight of additive per weight of FD-DVS form, preferably wherein said additive is free of manganese or substantially free of manganese, or wherein the composition is a frozen direct vat set (F-DVS) comprising 2% to 70% of an additive, preferably 3% to 50% of additive, more preferably 4% to 40% of additive, even more preferably 10-40% of additive or 20-35% of additive, measured as weight of additive per weight of the F-DVS form, preferably wherein said additive is free of manganese or substantially free of manganese.

7. The composition according to the preceding claim selected from the group consisting of sodium caseinate, inositol, monosodium glutamate, sodium ascorbate, sucrose, maltodextrin, inosine monophosphate (IMP), inosine, polysorbate 80, glutamic acid, lysine, sodium glutamate, malt extract, whey powder, yeast extract, gluten, collagen, gelatin, elastin, keratin, albumin, and mixtures thereof.

8. The composition according to the preceding claim, comprising sodium caseinate, inositol, monosodium glutamate and sodium ascorbate.

9. The composition according to any of the preceding claims, wherein the lactic acid bacteria comprise manganese transporter having at least 55%, such as at least 60%, 65%, 70%, 75%, 80%, 85%, 90%, 95%, 96%, 97%, 98%, 99% or 100% sequence identity with the sequence of any one of SEQ ID NO: 1-3.

10. The composition according to any of the preceding claims, wherein the lactic acid bacteria are free of a superoxide dismutase, preferably free of a manganese superoxide dismutase.

11. The composition according to any of the preceding claims, wherein the lactic acid bacteria are selected from a group consisting of Lactobacillus plantarum, Lactobacillus fermentum, Lactobacillus reuteri, Lactobacillus sakei, Lactobacillus brevis, Lactobacillus casei, Lactobacillus paracasei, Lactobacillus salivarius, Lactobacillus alimentarius, Pediococcus acidilactici, Lactobacillus rhamnosus and Lactobacillus kefiri.

12. The composition according to any of the preceding claims, wherein the fungi is yeast and/or mold, preferably wherein the fungi is a yeast selected from the group consisting of Torulaspora spp., Cryptococcus spp., Saccharomyces spp., Yarrowia spp., Debaryomyces spp., Candida spp. and Rhodoturola, preferably wherein Debaromyces spp. is Debaromyces hansenii and/or wherein the fungi is a mold selected from the group consisting of Aspergillus spp., Cladosporium spp., Didymella spp. or Penicillium spp. preferably wherein Penicillium spp. is Penicillium crustosum, Penicillium paneum, Penicillium cameum, or Penicillium roqueforti.

13. A food product comprising the composition according to any of the preceding claims.

14. The food product according to the preceding claim, wherein the food product is a fermented food product, preferably a thermophilic fermented food product or a mesophilic fermented food product, more preferably yogurt or cheese.

15. Use of a composition according to any of the previous claims 1-12 as to inhibit growth of fungi in a food product, preferably wherein the food product is a fermented food product, more preferably a thermophilic fermented food product or a mesophilic fermented food product, more preferably yogurt or cheese.
